(19) United States
(12) Patent Application Publication
(10) Pub. No.: US 2013/0144746 A1
(43) Pub. Date: Jun. 6, 2013

(54) METHODS, DEVICES AND SYSTEMS FOR THE GENERATION OF REQUESTS FOR QUOTES FROM AGGREGATED CONSTRUCTION-RELATED AND PERMITTING INFORMATION

(71) Applicant: Tam A. PHUNG, Woodside, CA (US)

(72) Inventor: Tam A. PHUNG, Woodside, CA (US)

(21) Appl. No.: 13/705,504

(22) Filed: Dec. 5, 2012

Related U.S. Application Data
(63) Continuation-in-part of application No. 13/312,059, filed on Dec. 6, 2011.

(51) Int. Cl. G06Q 30/02

(52) U.S. Cl. CPC G06Q 30/0611
USPC 705/26.4

(57) ABSTRACT

A computer-implemented method may comprise accessing a database comprising construction permitting information over a computer network; collecting construction permitting information for a plurality of construction projects from the accessed database and storing the collected construction permitting information. Each of the construction protects may be associated with a respective identified party. Information corresponding the plurality of construction projects may then be aggregated into a plurality of aggregated requests for quotes (RFQs), which may be stored in an RFQ database that is selectively accessible over the computer network. One or more vendor offers may be received against one or more of the aggregated RFQs. The vendor offer may be only selectively visible to the respective identified parties associated with the constructions projects against which the vendor offer has been received.

### CROSS-REFERENCE TO RELATED APPLICATIONS

This is a continuation-impart of application Ser. No. 13/312,059, filed Dec. 6, 2011, which application is incorporated herein by reference in its entirety and from which priority is claimed under 35 U.S.C. §120.

### BACKGROUND

In commercial transactions, it sometimes occurs that one or more suppliers may provide products or services at discounted rates, if only they had a sufficient number of customers for those products or services. Suppliers often cannot easily identify those customers who would, in aggregate, be sufficient to justify offering discounted rates for bulk commerce. Similarly, customers often cannot easily identify groups who, in aggregate, may command sufficient market power to be able to convince suppliers to provide desired products or services at discounted rates.

One case in which this presents a particular problem is that of capital improvements. When a building owner or tenant seeks to make capital improvements, it sometimes occurs that the cost of those improvements, for small projects, may be large enough to make the project untenable. If the project were larger, the savings developed from economies of scale, in combination with the savings developed from improvement in physical plant, may make the project worthwhile. In these circumstances, if individual owners making those improvements could band together, they may be able to obtain a volume rate from sellers.

Individual owners face both the difficulty of finding other such owners, and the difficulty that other such owners may have distinct needs which make aggregating their purchases more complicated. To obtain the best opportunity, those individual owners would want to agree on a common set of purchases to present to sellers. Distinctions between individual owners may include the amount of products they wish to obtain, the location at which they want to use them, and the amount of capital to be invested in making long-term cost reductions. For example, distinct owners may have differing desires regarding the energy-efficiency or other environmental friendliness of the improvements they wish to make, with the effect that they desire differing building products. Examples may include: different HVAC equipment, insulation, windows, and the like.

Known methods of group purchasing include aggregation of multiple buyers to obtain discounts from sellers. While these known methods generally achieve the goal of obtaining, volume discounts, they have drawbacks as indicated above. They also have drawbacks in that they often involve the financial commitment of some number of buyers before sellers are willing to financially commit to better prices.

### BRIEF DESCRIPTION OF THE DRAWINGS

FIG. 1. is a diagram of a system according to one embodiment,

FIG. 2 is a diagram of a method according to one embodiment.

FIG. 3 is a diagram of a method according to one embodiment.

FIG. 4 is a diagram of a method according to one embodiment.

FIG. 5 is a diagram of a method according to one embodiment

FIG. 6 shows a diagram of a method according to one embodiment.

FIG. 7 is a diagram illustrating further aspects of one embodiment.

FIG. 8 is a flowchart of a computer-implemented method according to one embodiment.

FIG. 9 is a flowchart of a computer-implemented Method according to One embodiment.

FIG. 10 is a block diagram of a computing device with which embodiments may be implemented.

### DETAILED DESCRIPTION

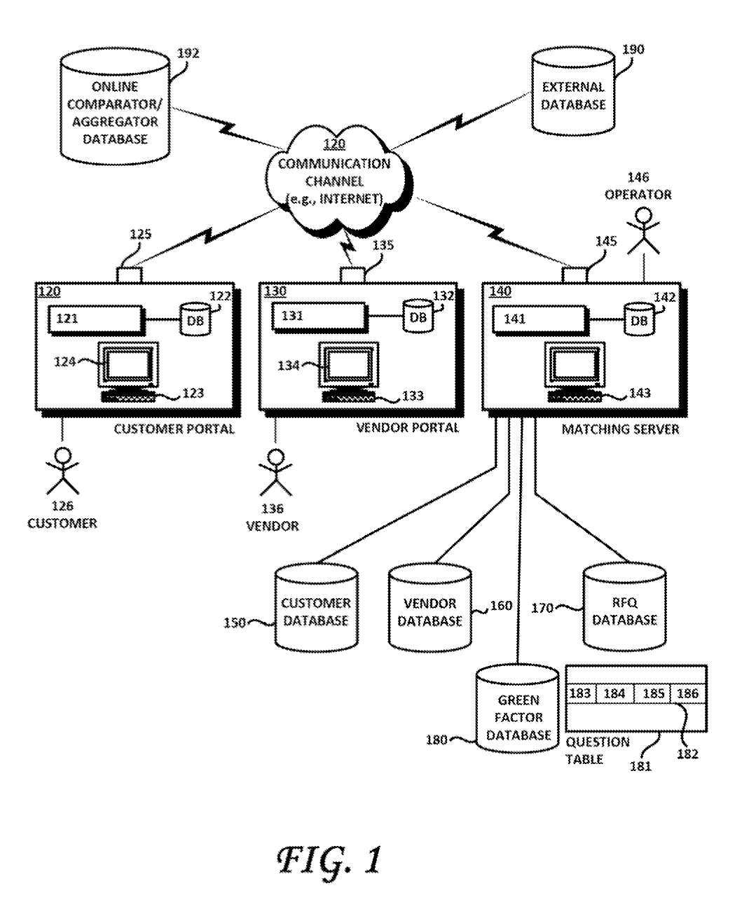

FIG. 1 is a diagram of a system according to one embodiment.

A system 100 capable of matching customers and vendors may comprise elements shown in the figure, including at least a. communication channel 110, one or more customer portals 120, one or more vendor portals 130, and a matching server 140. The system 100 may include other and further elements, such as for example product databases, advisory services, or otherwise.

The communication channel 110 couples the customer portals 120, the vendor portals 130, and the matching server 140. The communication channel 110 may include a LAN, a WAN, or an enterprise network, or any other communication technique which allows contact between and among the devices using the system 100. In one embodiment, the communication channel 110 may comprise an Internet connection coupled to a web site managed by, or on behalf of the matching server 140, as further described herein. In such cases, one or more of the customer portals 120 may communicate with the web site, and thus with the matching server 140, using an HTTP or HTTPS protocol, or a variant thereof. Similarly, in such cases, one or more of the vendor portals 130 may communicate with the matching server 140 using an HTTP or HTTPS protocol, or a variant thereof.

While this application primarily describes a system 100 in which customer portals 120 and vendor portals 130 communicate with the matching server 140 using the same communication channel 110, in the present context, there is no particular requirement for any such limitation. For example, customer portals 120 may communicate with the matching server 140 using a first web site, or using a web site managed by a first web server, while vendor portals 130 may communicate with the matching server 140 using a second web site, or using a web site managed by a second web server. Moreover, distinct types of customers may have distinct customer portals 120 which communicate with the matching server 140 using distinct communication channels, and distinct types of vendors may have distinct vendor portals 130, which communicate with the matching server 140 using distinct communication channels. Also, after reading this application, those skilled in the art would recognize that some customers for one purpose may also he vendors for another purpose, and vice versa.

The customer portals 120 each may comprise a processor 121, memory or mass storage 122 maintaining programs and data, input elements 123 such as a keyboard and pointing, device, output elements 124 such as a monitor and speakers, a connection 125 to the communication channel 110, such as for example an Internet connection, and may be used by one or more customers 126. For example, the customer portals 120 may comprise personal electronic devices, such as for example desktops, laptops, netbooks, touchpads, smart phones, or otherwise, and may comprise enterprise computing devices, such as for example servers, virtual machines, or otherwise.

Customer portals 120 may also comprise an aggregation or other marketplace of their own, such as for example a cooperative organization, an interinsurance exchange, a business entity which operates for the benefit of its members by aggregating their purchases and obtaining better market power thereby, or another type of group buying site or group buying organization. For example., a customer portal 120 may comprise a physical location, e.g., a “brick and mortar” location, in which one or more customer kiosks may be located which facilitate buyers entering possible purchase requests and which facilitate aggregation of those requests. Customer portals 120 could serve to collect buyers' purchase requests, or indications of interest, or could serve to actually aggregate those requests, or indications of interest, before they are sent to the matching server 140.

Customer portals 120 may also include, one or more web sites or other Internet services, which may be invoked from an application (such as by a smart phone or touchpad) or by an API or program at a customer server or customer web site. Each customer portal 120 may be disposed for use by a single customer 126, or for use by more than one customer 126, or more than one distinct agent of the same customer 126, such as for example distinct project managers for a single business entity.

The customer portals 120 may operate under control of program elements, executed by the processor 121 and maintained in the memory or mass storage 122, which perform the functions described herein. References to the customer portals 120 performing a function generally refer to a combination of hardware elements (such as the processor 121 and memory or mass storage 122) and software elements (such as the program elements) operating in combination or conjunction to achieve the described function. The term “customer”, and variants thereof, generally refers to any entity that may engage in commerce, such as by purchasing (or offering to purchase) goods or services. A customer may include a direct purchaser such as a subcontractor, or an indirect purchaser such as a contractor or a building owner. As described elsewhere herein, while this application sometimes refers to commerce involving upgrades or retrofitting of buildings, in the present context, there is no particular requirement for any such limitation.

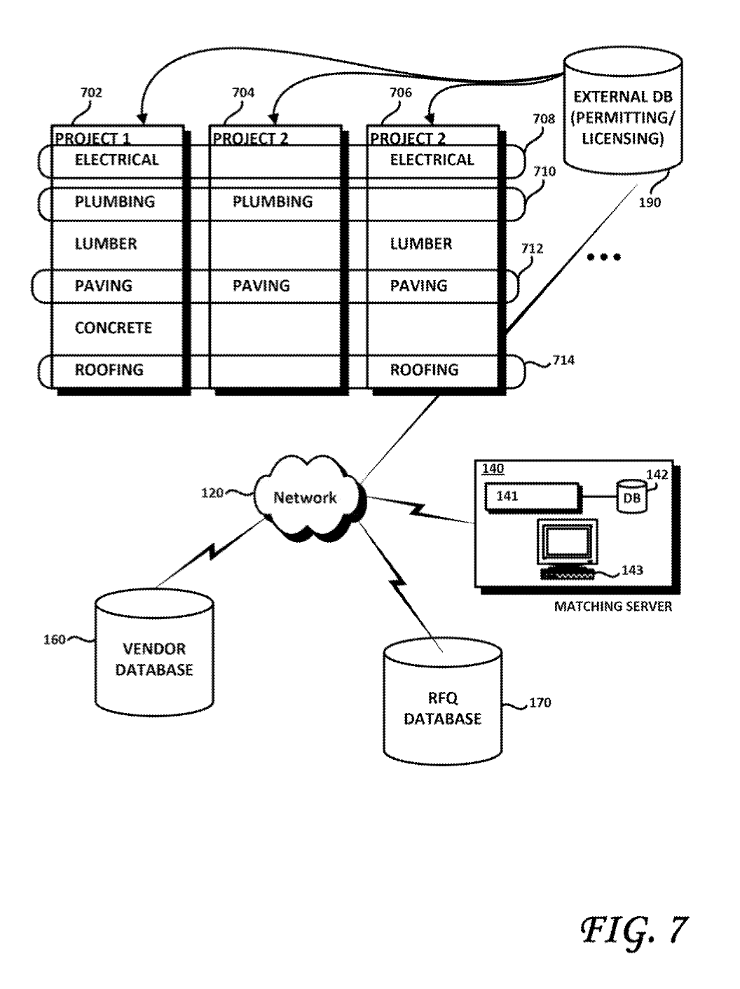

In one embodiment, customers 126 may enter information describing products and services the are interested in, such by sending that information from the memory or mass storage 122, or entering that information using the input elements 123. For example, a customer 126 may describe that they wish to upgrade a set of plain glass windows with a set of insulated windows, or may describe that they wish to upgrade an older HVAC system with a new HVAC. system. Customers 126 similarly can, in addition, or instead, enter information describing buildings they wish to upgrade or retrofit. For example, a customer 126 who has a building they wish to upgrade or retrofit may enter information about that building, including its age, construction type (such as for example concrete or wood), current use (such as for example office, retail, or warehousing). The customer 126 may also enter information about their costs (such as for example their utility bills, energy usage, or carbon footprint), information about their current willingness to make changes (such as for example a capital budget for upgrades, a time duration for completion of any upgrade or retrofit projection, or a degree of environmental friendliness desired for the project). The customer 126 need not enter all this information directly. The information may be supplied by another party, by reference to an external database, or may be inferred by the matching server 140 in response to a set of questions or another technique for obtaining information about the customer 126. Information relating to a building may be obtained from one or more external databases 190. Such external databases 190 (FIG. 7) may comprise, for example, building or construction permit databases, or may comprise repositories of city plans, tax records, or services like satellite mapping or street views of that area. According, to one embodiment, the external database(s) 190 may further comprise licensing information, rebate information, incentive information, government mandate information for example. Such external databases 190 may be publicly-accessible databases or may be databases which require specified credentials to access the information stored therein. According to one embodiment, all such permitting, licensing, rebate, mandate, and incentive information may be crawled by a software agent and. consolidated into one or more internal databases accessible only to the matching server 140.

Information about that building may be input to the matching server 140 using architectural drawings or building specifications. Cost information may be obtained from business financial statements, public utilities, third party cost information providers, or otherwise.

In one embodiment, cost information for one or more customers 126 may be maintained confidential by the matching server 140, at the request of those customers 126. For example, customers 126 may provide a range, or a lower or upper bound, for their capital budget. Optionally, customers 126 may provide a cost function which indicates a degree of perceived cost the customer 126 associates with aspects of the project For example, the customer 126 may be willing to tolerate a limited time duration for a building upgrade, but may note that each day required for the upgrade will cost the customer 126 in lost sales (such as for a commercial building) or inaccessibility to the public (such as for a government building).

The vendor portals 130 may each comprise a processor 131, memory or mass storage 132 maintaining programs and data, input elements 133 such as a keyboard and pointing device, output elements 134 such as a monitor and speakers, a connection 135 to the communication channel 110, such as for example an Internet connection, and may be disposed to be used by one or more vendors 136, For example, the vendor portals 130 may compose personal electronic devices, such as for example desktops, laptops, netbooks, touchpads, smart phones, mobile devices or otherwise, and may comprise enterprise computing devices, such as for example servers, virtual machines, or otherwise. Vendor portals 130 may also include one or more web sites or other Internet services, which may be invoked from an application or an “app” (such as by a smart phone, touchpad or other mobile device) or by an API or program at a customer server or customer web site. Each vendor portal 130 may be disposed for use by a single vendor 136, or for use by more than one vendor 136, or more than one distinct agent of the same vendor 136, such as for example distinct project managers for a single business entity.

The vendor portals 130 operate under control of program elements, executed by the processor 131 and maintained in the memory or mass storage 132, which perform the functions described herein. References to the vendor portals 130 performing a function generally refer to a combination of hardware elements (such as the processor 131 and memory or mass storage 132) and software elements (such as the program elements) operating in combination or conjunction to achieve the described function. The term “vendor”, and variants thereof, generally refers to any entity that may engage in commerce, such as by selling (or offering to sell) goods or services, A vendor may include as direct seller such as a franchisee or retailer, or an indirect seller such as a manufacturer or wholesaler. As described elsewhere herein, while this application sometimes refers to commerce involving upgrades or retrofitting o buildings, in the present context, there is no particular requirement for any such limitation.

In one embodiment, vendors 136 may enter information describing products and services they offer. For example, a vendor 136 who is a building contractor may describe products they offer for upgrading or retrofitting existing buildings to make them more energy efficient or otherwise more environmentally friendly. For each of these products or services, the vendor 136 may describe: (1) the nature of the product, and labor and materials associated with the product; (2) a green rating associated with the product; (3) a base cost and profit margin desired by the vendor 136 for that product; (4) possibly other information about the product In one embodiment, vendors 136 may in addition, or instead, enter information describing types of buildings they offer to upgrade or retrofit. For example, a vendor 136 regularly upgrades or retrofits particular types of buildings may enter information about those types of building, including similar information as may have been entered by customers 126 desiring work on those types of buildings. The vendor 136 need not enter all this information directly. The information may be supplied by another party, by reference to an external database, or may be inferred by the matching server 140. Information relating to buildings upgraded or retrofit by a particular vendor 136 may be obtained in similar manner as that for a single building for a particular customer 126. Information relating to particular products (and their prices) available from a vendor 136 may be obtained from a catalog from that vendor 136, from a website associated with that vendor 136, or from affiliate websites offering products originally from that vendor 136. Energy efficiency information may be obtained from business financial statements, public utilities, or otherwise, A green rating for a vendor 136, for a project proposed by the vendor 136, or for the products to be used in the project proposed by the vendor 136, may be determined as described below.

In one embodiment, cost information for one or more vendors 136 may be maintained confidential by the matching server 140, at the request of those vendors 136. For example, vendors 136 may provide a range, or a lower or upper bound, for their pricing. Optionally, vendors 136 may provide a price margin function which indicates a degree of desired margin the vendors 136 associates with aspects of the project. For example, the vendors 136 may be willing to accept a lesser margin per item, or per labor hour, so long as the total number of items, or labor hours, is sufficient that the total sale is profitable.

The matching server 140 may comprise a processor 141, memory or mass storage 142 maintaining programs and data, and a connection 145 to the communication channel 110, such as for example an Internet connection. The matching server 140 optionally may comprise input elements 143 such as a keyboard and pointing device, output elements 144 such as a monitor and speakers, and is disposed to be used by one or more matching operators 146, such as for example conducting operations at the behest of a matching service entity. In one embodiment, the matching server 140 may comprise a web server coupled to the Internet and capable of receiving and responding to responses from web browsers.

The matching server 140 operates under control of program elements, executed by the processor 141 and maintained in the memory or mass storage 142, which perform the functions described herein. References to the matching server 140 performing a function generally refer to a combination of hardware elements (such as the processor 141 and memory or mass storage 142) and software elements (such as the program elements) operating in combination or conjunction to achieve the described function.

References to functions performed by the matching, server 140 may also be performed at other devices, either at the request of the matching server 140, or to assist the matching server 140. For example, vendors 136 may perform repricing or determine their own risk margin directly, and may assist the matching server 140 in its functions.

The term “matching server”, and variants thereof, also generally refers to any entity that may provide the services described herein, whether as a public, service or as a business. For example, the matching server 140 may be operated as a business entity, in which the service of matching customers 126 and vendors 126 is performed by the matching server 140, and in which the business entity collects a fee for matching. As described herein, the matching server 140 constructs aggregated RFQ's in response to individual RFQ's provided by individual customers 126, may determine a savings to individual customers 126 due to an aggregated vendor offer associated with those aggregated RFQ's, distributes that savings among the customers 126 participating in the aggregated RFQ, and optionally reserves a portion of that savings for itself.

The matching server 140 attempts to aggregate RFQ's in response to a set of parameters, such as those described herein: (1) goals, including upgrade or retrofit needs, such as nature of the building project; (2) costs, such as those that may be expressed in monetary cost, energy usage, and carbon footprint; (3) expendable effort, such as those expressed in capital investment, time to completion, and green rating. The parameters can, but need not, be independent or orthogonal in nature. For example, capital investment the customer 126 is willing to expend, and time to completion the customer 126 is willing to endure, may be positively correlated. Collectively, the. parameters may define a possible aggregation of customers 126 (or particular customer projects). For selected tradeoffs between pairs of parameters, some pairs of customers 126 or customer projects may be relatively well suited for possible aggregation, while other pairs of customers 126 or customer projects may be relatively unsuited. For example, two customers 12.6 with nearly identical needs, costs, and willingness to expend effort (including green rating), may be likely to be relatively well suited for aggregation, while two customers 126 with very different needs, costs, and willingness to expend effort, may not. Collectively, each vendor 136 (or particular vendor product or project) may also be measured for suitability for possible aggregation of customers 126 (or customer projects). For selected tradeoffs between pairs of parameters, some vendors 136 may be particularly suitable, while other vendors 136 may be unsuitable.

In one embodiment, the matching server 140 may comprise a customer database 150, a vendor database 160, a request for quote (RFQ) database 170, and as “green rating” database 180, in one embodiment, each maintained in the memory or mass storage 142. Alternatively, one or more of these databases may be maintained at another location, logically or physically remote from the matching server 140, such as for example a storage device or a database server.

The customer database 150 may comprise a customer entry for each customer 126 (optionally, for each set of customers 126 who wish to band together before operation of the matching server 140). Each customer entry is associated with a set of RFQ's in the RFQ database 170. In one embodiment, each customer entry is associated with a set of RFQ's for the customer 126, possibly including aggregated RFQ's, as described below, which may be themselves associated with more than one customer 126.

Similarly, the vendor database 160 may comprise a customer entry for each vendor 136 (optionally, for each set of vendors 136 who wish to band together before operation of the matching server 140). Each vendor entry is associated with a set of vendor offers in the RFQ database 170. In one embodiment, each vendor offer is associated with a set of customers 126 who have been presented with the vendor offer, or who have accepted the vendor offer, or otherwise.

Similarly, the RFQ database 470 may comprise an RFQ entry for each RFQ, including for each individual RFQ associated with a single customer 126, and for each aggregated RFQ associated with more than one customer 126. The RFQ database 170 also may comprise a vendor offer entry for each vendor offer, including, for each individual vendor offer associated with an individual RFQ, and each aggregated vendor offer associated with an aggregated RFQ. The matching server 140 uses the RFQ database 70 to match and aggregate RFQ's, to track vendor responses to aggregated RFQ's, to track customer responses to those aggregated vendor offers, and to maintain risk margin information, as further described herein.

The green rating database 180 may comprise a green value for each customer 126, and in one embodiment, for each vendor 136, for each type of green rating (environmental friendliness, animal friendliness, child safety, and otherwise). In one embodiment, the green rating database 180 also may comprise a question lookup table 181, as further described herein for adjusting the green value associated with a customer 126 in response to an interactive dialog with that customer 126. As further described herein, the question lookup table 181 may comprise a set of questions 182, each of which is associated with a question text 183, a rating value 184 fir when to ask that question, a rating uncertainty 185 for when to ask that question, and a set of adjustments ISO associated with distinct possible answers to that question 182.

It is to be noted that the customer database 150, the vendor database 160, the RFQ database 170 and/or the green factor database 180 may be configured as one or more database within the matching server 140, locally coupled to the matching server 140 or remotely coupled to the matching server 140.

### Green Ratings

In one embodiment, the system 100 may determine a degree of environmental friendliness desired for the customer 126, or for an individual customer project (as described by an individual RFQ), sometimes referred to herein as a “green rating”. The green rating may help the customer 126 evaluate their home or business for potential environmentally friendly improvements, and help facilitate bidding between and among, contractors and other vendors 136, which may help reduce costs for labor and materials, and help the customer 126 select superior environmentally friendly products and technologies. The system 100 may determine the green rating in response to a number of possible factors.

The phrase “green rating”, and variants thereof, generally refers to any technique by which customers 126 may be distinguished with respect to their environmental friendliness. For example, such techniques may include a numerical scale, a set of categories, or otherwise. As further noted herein, a “green rating” may also refer to another measure for a project. For example, a distinct type of green rating may refer to distinguishing with respect to animal friendliness, child safety, or as otherwise described herein. While this application generally uses “green rating” to refer to environmental friendliness, in the present context, there is no particular reason for any such limitation. After reading this application, those skilled in the art may recognize that these other alternative factors may also be implemented.

For example, with respect to environmental friendliness, in one embodiment, the system 100 may use the following set of green ratings:
1 leaf: The customer 126 does not assign any significant positive weight to environmental friendliness, and is not willing to endure any significant financial burdens to achieve environmentally friendly results. An example of a 1 leaf customer may be a bankruptcy trustee mandated by law to maximize returns to creditors.
2 leaves: The customer 126 assigns very little weight to environmental friendliness, and is willing to endure some, but not large, financial burdens to achieve environmentally friendly results. An example of a 2 leaf customer may be a homeowner association whose members may be concerned about the environmentally friendly nature of their community.
3 leaves: The customer 126 assigns some weight to environmental friendliness, and is willing to endure a medium degree of financial burden to achieve environmentally friendly results. An example of a 3 leaf customer may be public utility seeking political approval of a controversial project.
4 leaves: The customer 126 assigns significant weight to environmental friendliness, and is willing to endure large, but not extreme, financial burdens to achieve environmentally friendly results. An example of a 4 leaf customer may be a political party for which environmental concerns may be pan of its national agenda.
5 leaves: The customer 126 assigns extreme weight to environmental friendliness, and is willing to endure relatively heavy financial burdens to achieve environmentally friendly results. An example of a 5 leaf customer may be to government agency constrained by law to stay within mandated environmental limits.

While green ratings are described above as being whole numbers from 1 to 5, in the present context, there is no particular requirement for any such limitation. For example, green ratings may include decimal or fractional values, symbolic values, or otherwise. Similarly, while green ratings are described above using symbols such as leaves, in the present context, there is no particular requirement for any such limitation. For example, green ratings may be described using coins, or any other icon or picture, or any other symbol or no symbol at all) which is recognizable by customers 126 or by vendors 136.

The phrase “environmental friendliness”, and variants thereof, generally refers to any measure of how the project, or its deportment, affects environmental factors, including without limitation with respect to energy-efficiency, carbon footprint, pollutants, toxic substances, effects on community, effects on flora and fauna, effects on light and air, and otherwise. Environmental friendliness may comprise effects due to manufacture, transport, commerce in, or use of particular products and services. For example, with respect to a set of window panes, environmental friendliness may comprise their energy-efficiency the substances incorporated into those products, a measure of waste associated with their manufacture, and otherwise.

In one embodiment, in response to information about the customer 126, as described above, the system 100 attempts to classify the customer 126 into a green rating category. The system 100 interacts with the customer 126, such as using a software element at the customer portal 120, or a software element at the matching server 140, or otherwise. The software element presents a set of choices to the customer 126, receives one or more responses from the customer 126, and in response thereto, continues with a next set of choices to present.

In one embodiment, the interaction with the customer 126 (presentation of choices, reception of one or more responses) is repeated until the system 100 has determined a green rating for the customer 126 with sufficient confidence to associate that green rating, with the customer 126. Optionally, the system 100 may associate the green rating with the project requested by the customer 126, again, with sufficient confidence to associate that green rating with that project.

In one embodiment, the system 100 directly asks the customer 126 to rate themselves on a scale indicative of environmental friendliness. For example, a “1 leaf” customer 126 may state that they only care about financial factors relating to the project, while a “5 leaf” customer 126 may state that they want to minimize carbon footprint even if that involves a heavy financial cost.

If the customer 126 is not sure about rating themselves, or if the system 100 wishes to confirm the self-rating by the customer 126, the system 100 asks the customer 126 a set of questions with respect to environmental friendliness.

In one embodiment, the system 100 asks the customer 126 about lifestyle factors which pertain to the customer 126 and which directly pertain to environmental friendliness, such as for example whether the customer 126 owns an electric vehicle or has home solar panels. The choices presented offer the customer 126 an opportunity to describe themselves by implication. In such cases, the choices presented may be selected for statistical correlation with classification of customers 126 with respect to environmental friendliness. For example, the system 100 may ask if the customer 126 owns an electric vehicle if the answer to that question is statistically correlated with a likelihood that the customer 126 would give greater or lesser weight to environmental friendliness.

Statistical measures of lifestyle choices may be commercially available, which may be used by the system 100 to compute a measure of environmental friendliness in response to product preferences expressed by the customer 126. For example, there may be known collaborative filtering techniques used in the advertising industry which assign prospective clients to one of several “values and lifestyle” categories. In one embodiment, the system 100 assigns a green rating to each one of those values and lifestyle categories.

If the system 100 is able to obtain a green rating for the customer 126 in response to the self-rating of the customer 126 and in response to the direct lifestyle factors, it uses that green rating. If the system 100 wishes to confirm the green rating it is able to determine in response to those factors, it may proceed to ask the customer 126 about indirect lifestyle factors.

In one embodiment, the system 100 asks the customer 126 about lifestyle factors which pertain to the customer 126 and which only indirectly pertain to environmental friendliness, such as for example a zip code or census tract in which the customer 126 resides, or a political party affiliation associated with the customer 126.

Similar to the direct lifestyle factors, the choices presented offer the customer 126 an opportunity to describe themselves by implication. The choices presented may be selected for statistical correlation with classification of customers 126 with respect to environmental friendliness. For example, the system 100 may ask if the customer 126 has contributed to a political candidate known to favor issues which relate to environmental friendliness, if the answer to that question is statistically correlated with a likelihood that the customer 126 would give greater or lesser weight to environmental friendliness.

If the system 100 is able to obtain a green rating for the customer 126 in response to the self-rating of the customer 126 and in response to the direct lifestyle factors, it uses that green rating. If the system 100 wishes to confirm the green rating it is able to determine in response to those factors, it may proceed to asking the customer 126 about indirect lifestyle factors.

In each case, the system 100 resolves ambiguities using follow-up questions. For example, if the customer 126 responds to lifestyle questions with answers that are at as border for classification between distinct green ratings (for example, some of the customer's answers may be associated with a 2-leaf green rating while others of the customer's answers may be associated with a 4-leaf green rating), the system 100 groups the customer's answers into (1) those answers which are associated with a 2-leaf green rating, versus (2) those answers which are associated with a 4-leaf green rating, and (3) attempts to find further lifestyle questions which best distinguish between those groupings.

In one embodiment, the system 100 maintains a default rating, such as “3 leaves”, when the system 100 may have no information yet about the customer 126. Optionally, the default rating may he adjusted in response to a region in which the customer 126 is located, so that a first region may have a default rating of 3.50 leaves, while a second region may have a default rating of 2.75 leaves, and a 3rd region may have a default rating of 3 leaves.

In one embodiment, as the system 100 gleans information about the customer 126, the system 100 adjusts the green rating associated with that customer 126 and a measure of uncertainty about that green rating. The system 100 continues to ask questions of the customer 126, the questions being selected in response to their current adjusted green rating, until answers from the customer 126 include sufficient information that the system may reduce that measure of uncertainty about their green rating to below a selected threshold. Once the system 100 has an adjusted green rating for the customer 126 and the measure of uncertainty is sufficiently low, the system 100 may stop questioning the customer 126 to ascertain their green rating.

In one embodiment, the system 100 may apply fuzzy logic to select questions in response to the customer's 126 adjusted green rating. Alternatively, the system 100 may use the customer's 126 adjusted green rating to select a next question from a look-up table. For example, the system 100 may maintain a set of questions for each green rating, and associate the customer 126 with a particular green rating when the customer 126 answers “Yes” to more than X questions in one of the green ratings. For example, X may equal 3, thus, the system 100 may associate the customer 126 with a 2 leaf green rating after receiving 3 “Yes” answers to questions that are themselves associated with a 2 leaf green rating.

In one embodiment, the system 100 may also associate a rating with the customer 126 in response to the products they request for themselves or for a building they own. For example, if a customer 126 requests solar panels for their home, the system 100 may associate a more environmentally friendly green rating than if the customer 126 requests constructing a new swimming pool.

In one embodiment, the system 100 (either using a software element at the customer portal 120 or at the vendor portal 130, or a software element at the matching server 140 interacts with the vendor 136 and may determine a degree of environmental friendliness assessed for the project, also referred to herein as a “green rating”. The green rating may help the vendor 126 match their product offerings to potential environmentally conscious customers 126, and help facilitate aggregation of similar customers 126, which may help reduce costs for labor and materials, and help the vendor 136 aggregate similar customers 126 and technologies. The system 100 may determine the green rating in response to a number of possible factors:

The system 100 may calculate, or otherwise determine, a green rating for the vendor 136, in response to a reputation poll of customers 126 who rate the vendor 126, the project proposed by the vendor 136, or the products to be used in the project proposed by the vendor 136, on a scale indicative of environmental friendliness.

In one embodiment, the system 100 may facilitate the reputation poll of customers 126 using a social networking feature, in which each particular vendor 136 is associated with comments and ratings from a set of customers 126 who rate the vendor 136, the project proposed by the vendor 136, or the products to be used in the project proposed by the vendor 136. In such cases, customers 126 whose ratings are themselves rated as “helpful” or “not helpful” may themselves have their ratings of vendors 136 weighted more or less, as indicated by their fellow customers 126.

The system 100 may calculate, or otherwise determine, a green rating for the vendor 136, in response to a set of customers 126 associated with that vendor 136, such as for example (1) green ratings assessed themselves by those customers 126; (2) lifestyle factors which pertain to those customers 126 and which directly pertain to environmental friendliness, as described above; (3) lifestyle factors which pertain to those customers 126 and which only indirectly pertain to environmental friendliness, as described above.

In one embodiment, the system 100 may obtain a statistical distribution of customers 126 for each vendor 136, and compute an average of green ratings for those customers 126 to obtain a green rating for that vendor 136. Similarly, the system 100 may compute a weighted average of green ratings for those customers 126, each customer 126 having a weight associated with a fraction of that vendor's sales which that customer 126 accounted for, or optionally, a weight associated with the fraction of that vendor's different products which that customer 126 used.

The system 100 may calculate, or otherwise determine, a green rating for the products offered or sold by the vendor 136, in response to a set of metrics associated with those products, such as for example energy efficiency, carbon footprint, and fraction of those products offered or sold by that vendor 136.

The system 100 may calculate, or otherwise determine, a green rating for the vendor 136, or for products offered or sold by the vendor 136, in response to a rating from a rating agency, such as for example the Department of Energy, ERA, or another government agency, or for example a consumer products rating agency or other private rating agency, such as the LEED rating system by the US Green Building Council.

In one embodiment the system 100 uses a set of green ratings similar to those it associates with customers 126.

In one embodiment, it is contemplated that both customers 126 and vendors 136 may be involved in a project relating to a building, or a portion of the building, to upgrade or retrofit that building. Accordingly, vendors 136 may offer one or more collections of products and services related to upgrading or retrofitting that building, and customers 126 may one or more of those collections, or some portion of one or more of those collections. Distinct collections may vary in price and in energy saved for the customer 126, and in set of green ratings for the products and services in that collection, or in a green rating for the collection considered as a whole.

For example, a vendor 136 may offer (1) a set of insulated windows, and installation of those windows, to replace the windows already installed in the building, and (2) a retrofit of the HVAC and water-heating system, including new heating and cooling elements, ductwork, fans, pipes, pumps, and related equipment.

### Determining Green Rating

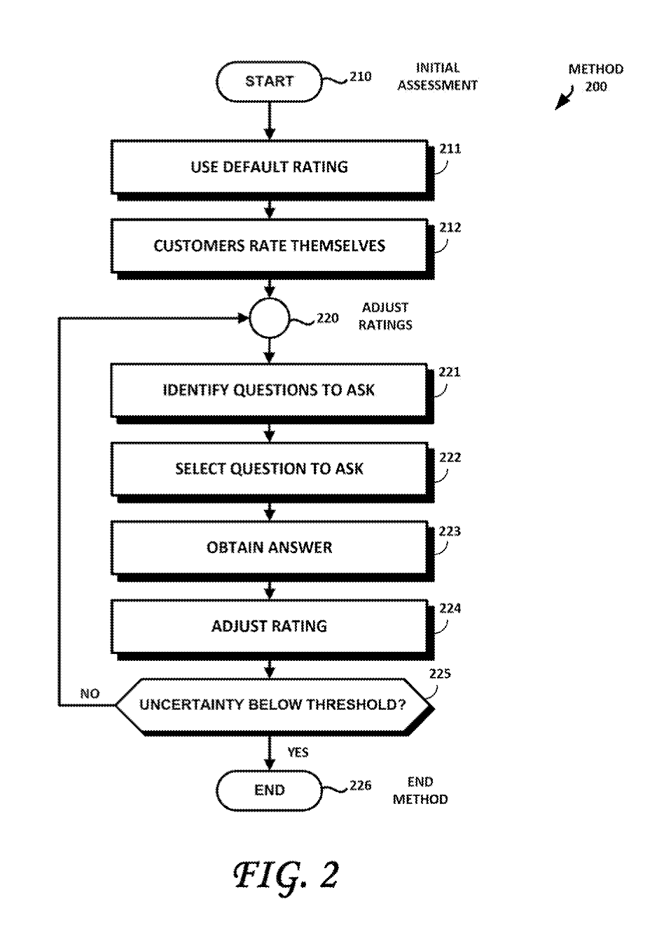

FIG. 2 is a diagram of a method according to one embodiment.

A method 200 includes flow points and steps as shown in the figure, including at least flow points as described below.

Initial assessment: At a flow point 210, the method 200 is ready to make an initial assessment of the customer 126.

At a step 211, the method 200 associates the customer 126 with a default green rating and an uncertainty for that green rating. As described above, the default green rating may be adjusted in response to location or other factors. The uncertainty may also be adjusted in response to location or other factors.

At a step 212, the method 200 optionally asks the customer 126 to rate themselves with a green rating.

Rating adjustment: At a flow point 220, the method 200 is ready to adjust the green rating in response to questions.

At a step 221, the method 200 identifies a set of questions in response to the current green rating and uncertainty. As described above, the questions may relate to lifestyle factors which directly or indirectly pertain to the green rating.

At as step 222, the method 200 selects one of those questions and asks the customer 126.

As described herein, the method 200 reviews the question look-up table 181 with a set of questions 182, each of which may have an associated question text 183. Each of those questions 182 may have an associated green value 184, optionally an associated uncertainty 185, and an associated set of adjustments 186 associated with distinct possible answers to that question 182.

If a particular question 182 is sufficiently close to the current green value (and optionally, uncertainty), the question 18.2 is eligible for asking. In one embodiment, the method 2.00 selects one such question 182 from the question look-up table 181 that is eligible for asking, either using a random or pseudorandom technique, or using a fuzzy logic technique. The fuzzy logic technique may be applied in response to the question 182, metadata about the question 182, and other information about the customer 126. Haying selected one such question 182, the method 200 may present that question 182 to the customer 126. Optionally, a question 182 may be applied to information about the customer 126, without the requirement that the customer 126 actually review and answer it.

At a step 223, the method 200 obtains an answer (or refusal to answer) from the customer 126. In one embodiment, each question 182 may have a first adjustment 186 associated with a “Yes” answer, and a second adjustment 186 associated with a “No” answer, and optionally a 3rd adjustment 186 associated with refusal to answer or associated with a non meaningful answer. Alternatively, the question 182 could be multiple-choice, and have a distinct adjustment 186 associated with each possible response, including a failure to respond.

At a step 224, the method 200 adjusts the customer's green rating, and the uncertainty associated with the customer's green rating, in response to the customer's answer, and in response to the adjustment 186 described with respect to the earlier step 223.

At a step 225, the method 200 may determine if the uncertainty associated with the customer's green rating is below a selected threshold, such as for example no more than 0.2 leaves. If so, the method 200 may proceed with the flow point 230, where it is effectively complete and finishes up. Otherwise, the method 200 continues with the flow point. 220, where the method 300 continues to further adjust the customer's green rating,

At a flow point 230, the method 300 is effectively complete for this customer 126. The method 300 records the customer's green rating in a data structure at the matching server 140 (or optionally, at a database accessible to the matching server 140), and stops.

While this description has primarily been with respect to environmental friendliness, the system 100 may also rate customers 126 and vendors 136 with respect to other factors, such as for example (1) animal friendliness, e.g., customers 126 may prefer vendors 136 which may be more friendly to animal safety or welfare, or which may be vegetarian or vegan in their origin: (2) child safety, e.g., customers 126 may prefer vendors 136 which may be more concerned about child safety, or which have better compliance records with child safety laws; (3) human rights, e.g., customers may prefer vendors 136 which produce their products according to the standards of one or more human rights ratings, such as those vendors 136 which abstain from manufacture in particular countries; (4) minority-owned businesses, e.g., customers 126 may prefer vendors 136 which ma be minority-owned or minority-controlled, or which have an active affirmative action plan; (5) political standing, e.g., customers 126 may prefer vendors 136 which may be more unionized or less unionized, or which lean more toward the Democratic party or the Republican party; (6) religious affiliation, e.g., customers 126 may prefer vendors which have a particular religious affiliation, or which do not have any particular religious affiliation; (7) other standards that customers 126 may define. The system 100 may also provide combined ratings for vendors 136 in response to more than one of these r other factors. Naturally, the system 100 does not participate with ratings which may be prohibited by law.

These alternative factors are sometimes referred to herein as “green factors”.

### Matching and Aggregation

The matching server 140 generally collects customers 126 (sometimes called “buyers”) into a set of aggregated RFQ's (requests for quotes), for vendors 136 (sometimes called “sellers”) to bid on those aggregated RFQ's. Each aggregated RFQ represents a set of customers 126 with a combination of parameters (goals, costs, and effort) which may be sufficiently similar that the matching server 140 may present those of customers 126 to a particular vendor 136 for a group offer.

Collectively, a single aggregated RFQ is presented to a vendor 136 on behalf of a number of customers 126, The matching server 140 collects the sets of parameters (needs, costs, efforts) for each customer 126 and attempts to create a single aggregated RFQ which represents that group of customers 126, This may have the effect that the matching server 140 combines RFQ's from each individual customer 126 into an aggregated RFQ on behalf of a group of customers 126.

Aggregated RFQ's may be formed in response to the vendor's ability to support a region where the customers 126 are located. The matching server 140 maintains information from each vendor 136 regarding a coverage area, such, as a list of zip codes, a radius from the main office of the vendor 136, or a set of locations indicated by the vendor 136 as their coverage area. Optionally, coverage areas may apply primarily to labor, as materials may be shipped in from relatively remote locations.

Aggregated RFQ's may be formed in response to desired materials, including amounts that could be shipped, any shipping charges, or time delays associated with shipping. Customers 126 desire a set of materials to be included in their projects, such as for example, (1) a set of solar panels, (2) a set of energy-efficient lighting. While the particular materials to be included generally have to match those requested by the customer 126, the amounts may be aggregated by summing across multiple customers 126. For example, if a first customer 126 desires 10 solar panels and 5 lighting systems, while a second customer 126 desires 20 solar panels but no lighting systems, a vendor 136 may make a group offer for 30 solar panels and 5 lighting systems, with the customers 126 to divide up the materials.

Aggregated RFQ's may be formed in response to desired financial terms, including amounts to be paid up front, amounts of time to be paid, at what progress points, and any interest rate. Vendors 136 such as general contractors offer financial terms for their projects. While financial terms offered by vendors 136 generally have to be matched by customers 126 who wish to accept the vendor's group offer, the amounts may be aggregated by summing across multiple customers 126. Thus, if a first customer 126 is willing to pay 10% up front for a $100,000 project (thus, $10,000), while a second customer is willing to pay 5% up front for a $500,000 project (thus, $25,000), a vendor 136 may have a group offer accepted if the amount paid up front is at most the total (thus, $35,000).

Aggregated RFQ's may he formed in response to desired time for performance, as described herein. In one embodiment, each Aggregated RFQ may have an allowed time for customer 126 to join an aggregation (T1), a deadline for vendors 136 make a group offer (T2), a deadline set by a vendor 136 by which customers 126 must respond to the group offer (T3), a deadline for the vendor 136 to ratify the group offer (T4), and a deadline by which the vendor 136 promises to perform (T5). Other associated times may exist, such as an extended acceptance time at less favorable terms, or an extended performance time with a late penalty, and otherwise.

Aggregated RFQ's may be formed in response to green rating (or “green rating” with respect to other factors, as noted above), if the customers 126 associated with those aggregated RFQ's place decision-making weight on one or more “green ratings”, with the effect that customers 126 whose green rating is similar are more likely to be associated with an aggregated RFQ, and those aggregated RFQ's ma be more likely to be associated with vendors 136 whose green rating. is compatible with those customers 126.

Aggregated RFQ's may be adjusted with respect to industry, such as if the customers 126 are mostly grocery stores or if the customers 126 are mostly industrial buildings.

Aggregated RFQ's may optionally be adjusted with respect to customer preferences, such as for example if a particular customer 126 requests a particular vendor 136 as being preferable, due to a positive earlier experience, or otherwise.

Those skilled in the art may see that Aggregated RFQ's may he formed or adjusted responsive to all measurable parameters which may be used as parameters for each customer 126 for customer project). This may have the effect that each factor associated with customers 126 is used to determine whether a set of customers 126 are relatively well suited for aggregation. In one embodiment, factors may include: location of project, size of project, time urgency, green rating, and otherwise.

In one embodiment, customer aggregation is described with respect to three distinct types of RFQ's, (1) time and materials RFQ's, (2) commodity RFQ's without tiered pricing, and (3) commodity RFQ's with tiered pricing.

In any case in which a customer 126 submits an RFQ, the matching server 140 may determine T1 (deadline to join an aggregation), T2 (deadline for making vendor offers). T3 (deadline for accepting vendor offers), T4 (deadline for vendor to ratify the aggregated RFQ), and T5 (deadline for vendor performance). As to T1, T2, T3, and T4, the matching server 140 enforces those due dates by only aggregating RFQ's and matching them with aggregated vendor offers within those times. As to T5, the matching server 140 may enforce that due date only with respect to a price differential that may be specified if the vendor does not perform within that

(1) With respect to time and materials RFQ's, the matching server 140 generally collects RFQ's into aggregated RFQ's when possible, may determine if there is an aggregated vendor offer for each aggregated RFQ, and if so, facilitates the conduct of buyers and the vendor for that aggregated vendor offer. For each buyer entering the aggregated RFQ, the matching server 140 may determine the risk margin. If the risk margin is paid, the matching server 140 enters that buyer unequivocally into the aggregated. RFQ, with the risk margin being nonrefundable earnest money by the buyer that compensates the vendor if the buyer were not to go through with the aggregated RFQ. As such, the paid risk margin may operate as liquidated damages, as a hedge against non-performance on the part of the buyer. This could have the same effect as the “committed” quantity (equivalent in currency terms) so that the vendor has enough information to justify the most competitive bid, such is the case in master procurement contract negotiations. if the risk margin is not paid, the matching server 140 may enter the buyer into the aggregated RFQ, but notes that the buyer may later be removed from the aggregated RFQ, such as if the vendor is not satisfied with the possibility that buyers will pull out of the aggregated RFQ.

(2) With respect to commodity RFQ's without tiered pricing, the matching server 140 generally collects RFQ's into aggregated RFQ's when possible. The vendor may have generally presented an aggregated vendor offer which may have a minimum quantity associated with it, such as described herein. For example, the vendor could offer a 20% discount if the aggregated RFQ includes at least 1,000 units of product. For each buyer entering the aggregated RFQ, the matching server 140 may determine the risk margin. If the risk margin is paid, the matching server 140 enters that buyer unequivocally into the aggregated RFQ as described above. If the risk margin is not paid, the matching server 140 may enter the buyer into the aggregated RFQ, but notes that the buyer may later be removed from the aggregated RFQ, as described above.

If the risk margin is paid for a sufficient quantity, the aggregated RFQ ma proceed. If the risk margin is not paid for a sufficient quantity, the matching server 140 may determine if it may be valuable to pay the remaining risk margin itself, and resell the quantity of product that buyers have not unequivocally covered. For example, if the vendor offered a 20% discount if the aggregated RFQ includes at least 1,000 units of product, but only 900 units of product were guaranteed by buyers, the matching server 140 may pay the risk margin for the remaining 100 units of product, and attempt to resell those units itself, at a price between the aggregated RFQ price and the full retail price. This is described below as a “hot RFQ”.

In any case in which the aggregated RFQ has an aggregated vendor offer, and the deal proceeds, the matching server 140 may allocate the savings from the aggregated RFQ to the buyers associated with that aggregated RFQ, as described herein. The initiating buyer, that is, the first buyer to submit an individual RFQ, may be allocated 5% (for example) of the savings as an incentive to buyers to initiate new RFQ's that may become aggregated RFQ's. The rest of the savings may be allocated to the buyers in proportion to their participation in the aggregated RFQ. Optionally, the matching server 140 may allocate a portion of the savings to itself, and distribute the rest of the savings to the buyers.

(3) With respect to commodity RFQ's with tiered pricing, the matching server 140 generally collects RFQ's into aggregated RFQ's when possible. The vendor may have generally presented an aggregated vendor offer which may have as minimum quantity associated with it, such as described herein. For example, the vendor could offer a 10% discount if the aggregated RFQ includes at least 500 units of product, a 20% discount if the aggregated RFQ includes at least 1,000 units of product, and a 25% discount if the aggregated RFQ includes at least 1,500 units of product. For each buyer entering the aggregated RFQ, the matching server 140 may determine the risk margin. If the risk margin is paid, the matching server 140 enters that buyer unequivocally into the aggregated RFQ, as described above. if the risk margin is not paid, the matching server 140 may enter the buyer into the aggregated. RFQ, but notes that the buyer may later be removed from the aggregated RFQ, as described above. !Tithe risk margin is paid, the aggregated RFQ may proceed for that quantity.

In any case in which the aggregated RFQ may have an aggregated vendor offer, and the deal proceeds, the matching server 140 may allocate the savings from the aggregated RFQ to the buyers associated with that aggregated RFQ, as described herein. The initiating buyer, that is, the first buyer to submit an individual RFQ, may he allocated 5% (for example) of the savings as an incentive to buyers to initiate new RFQ's that may become aggregated RFQ's, The rest of the savings may be allocated to the buyers in proportion to a formula described herein. In one embodiment, the formula allocates exponentially greater savings to buyers when those buyers participate more towards savings due to the aggregated RFQ. Optionally, the matching server 140 may allocate a portion of the savings to itself, and distribute the rest of the savings to the buyers.

### Customer Aggregation

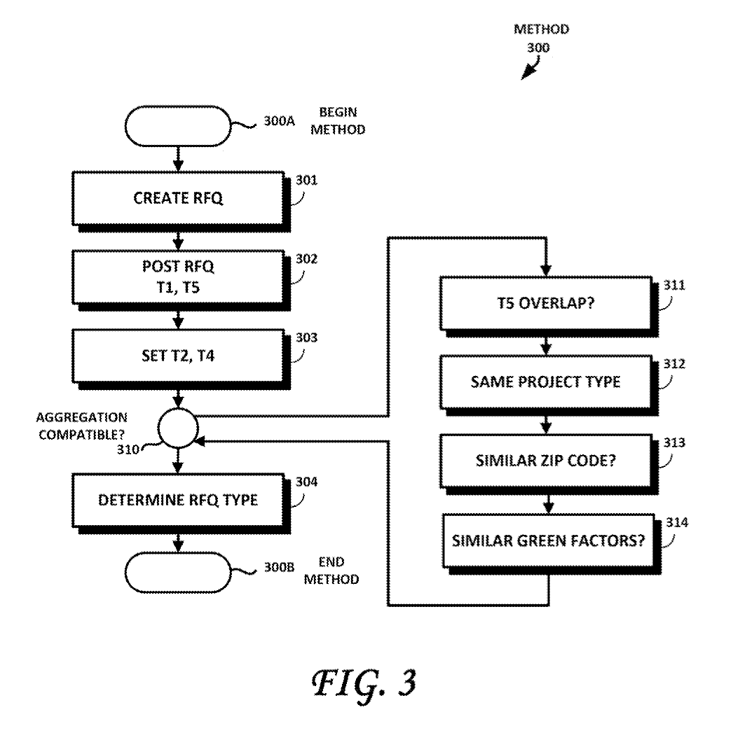

FIG. 3 is a diagram of a method according to one embodiment.

A method 300 may comprise steps as shown in the figure, including at least steps as described below.

A flow point 300A indicates a beginning of the method 300.

At a step 301, a customer 126 finds a product or service at the matching server 140. In response to the customer 126, the matching server 140 creates an RFQ for possible aggregation. Alternatively, an RFQ may be created in response to an operator of the matching server 140 or another entity tasked with creating RFQ's, such as an audit partner or a customer service representative for the matching server 140 (which may itself be operated as a separate business entity), and the method 300 may proceed with the step 310. Alternatively, a customer 126 may inquire about a product or service not available at the matching server 140, which may result, after the matching server 140 may determine if a similar product or service is available, in a new RFQ being created for the similar product or service.

At a step 302, the RFQ is posted on the matching server 140, and given an identifying number. The initiating customer 126, who created the RFQ, or the operator if there was no such customer 126, sets values for T2 (deadline for making a group offer) and T5 (deadline for performance).

At a step 303, the customer 126 and an operator jointly set values for T1 (deadline for joining aggregation) and for T4 (deadline for ratifying group offer), For example, the customer 126 may select values in response to a set of values suggested by the operator, or the customer 126 may just set the values themselves.

A flow point 310 indicates the method 300 is ready for an aggregation compatibility check.

For each aggregated RFQ, whether for times and materials RFQ's, commodity RFQ's without tiered pricing, or commodity RFQ's with tiered pricing, the method 300 performs an aggregation compatibility check. In general, each new RFQ or each attempt to join an RFQ to an existing aggregated RFQ, is checked for compatibility with the existing aggregated RFQ. In one embodiment, the method 300 performs the following checks substantially in parallel. In one embodiment, these checks may be performed by the matching server 140, or by another computing device at the request of the matching server 140.

At a step 311, the method 300 may determine if the T5 values for the new RFQ and the aggregated RFQ overlap. If so, the new RFQ may be eligible for aggregation.

At a step 312, the method 300 it may determine if the project type is the same. For a first example, for projects in which labor is required, such as time-and-material projects, the location for the projects should be within driving distance, and the type of labor involved should be similar. For a second example, for projects in which products are being delivered, the delivery location should be within shipping distance. Alternatively, the sending location should be sufficiently similar that a vendor 136 may be willing to undertake the delivery. If the project type is the same, the new RFQ may be eligible for aggregation.

At a step 313, the method 300 may determine if the zip code for the project is similar, hi performing, this action, the method 300 may use a database of zip codes, indicating for each zip code, which other zip codes are relatively dose. As noted with respect to project type, zip code similarity may be measured differently for projects involving labor and for projects involving product delivery. If the zip codes for the projects are similar, the new RFQ may be eligible for aggregation.

If the new RFQ and the aggregated RFQ involve delivery of products, the method 300 may determine if those products are in the same category. For example, if the new RFQ involves delivery of one or more touchpad devices, those devices should generally be from the same manufacturer (if the manufacturer is the vendor 136). Alternatively, if a reseller is the vendor 136, it is possible the touchpad devices could simply all be related to consumer electronics. If the products are in the same category, the new RFQ may be eligible for aggregation.

At a step 314, the method 300 may determine, for each green factor, that each of the categories for which a “green rating” may be determined, whether the customer 126 with the new RFQ may be concerned about using, a vendor 136 with a particular green rating for that green factor. In this comparison, the method 300 operates with respect to each such green factor in logical, parallel, with the effect that this issue may be addressed if the customer 126 is concerned with a green rating for environmental concerns or any other green factor noted above (e.g., animal friendliness, child safety, human rights. etc).

In each case, if the customer 126 is not concerned with that factor, the new RFQ may be eligible for aggregation.

In each case, if the customer 126 is concerned about that factor, the method 300 may determine if the new RFQ is similar, with respect to that factor, to the aggregated RFQ. In performing this action, the method 300 may use a database of “green ratings” for each such factor, or can determine the “green rating” for those factors for which the customer 125 is concerned, for the new RFQ and the aggregated RFQ, as described above for determining a “green rating” for the customer 126 themselves. This may have the effect that if the customer 126 is concerned about that factor, the method 300 (such as when performed by the matching server 140) can separately address that concern by asking the customer 126 what the specific “green rating” is for that factor for the new RFQ, and can determine the “green rating” for that factor for the aggregated RFQ.

In each case, if the customer 126 is concerned about that factor, and the new RFQ is not similar to the aggregated RFQ, the new RFQ may be not eligible for aggregation.

After reading this application, those skilled in the art will realize that the phrase “green factor” may be used for any factor for which the customer 126 is concerned, including environmental friendliness, animal friendliness, child safety, human rights, and any other factor noted herein. After reading this application, those skilled in the art will also realize that the method 300 does not operate on factors for which discrimination may be prohibited by law.

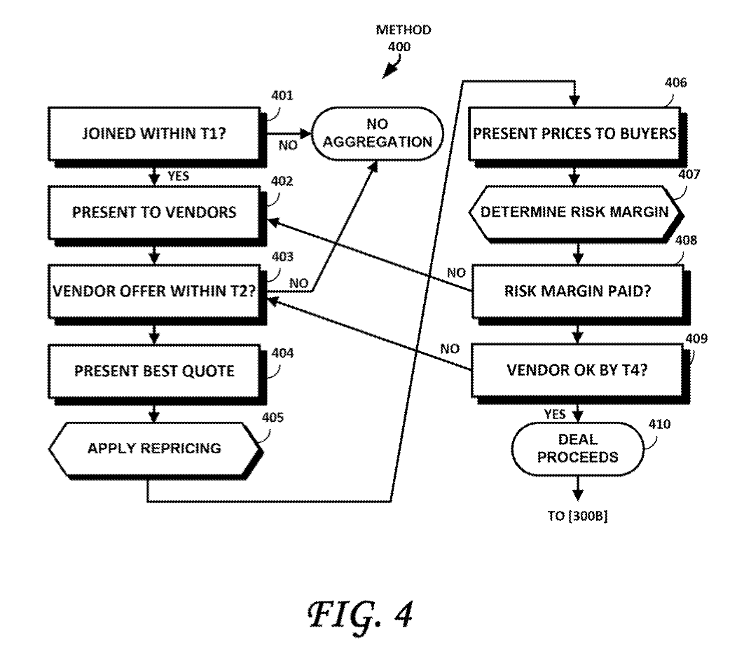

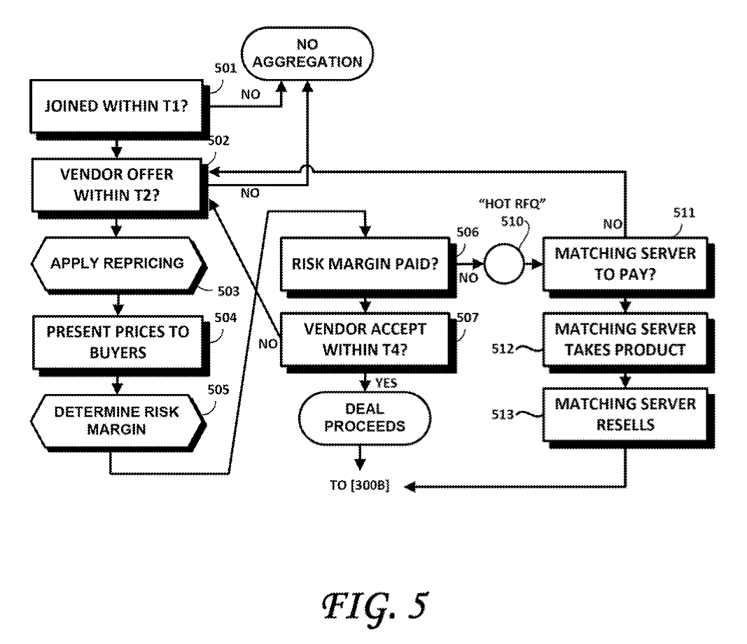

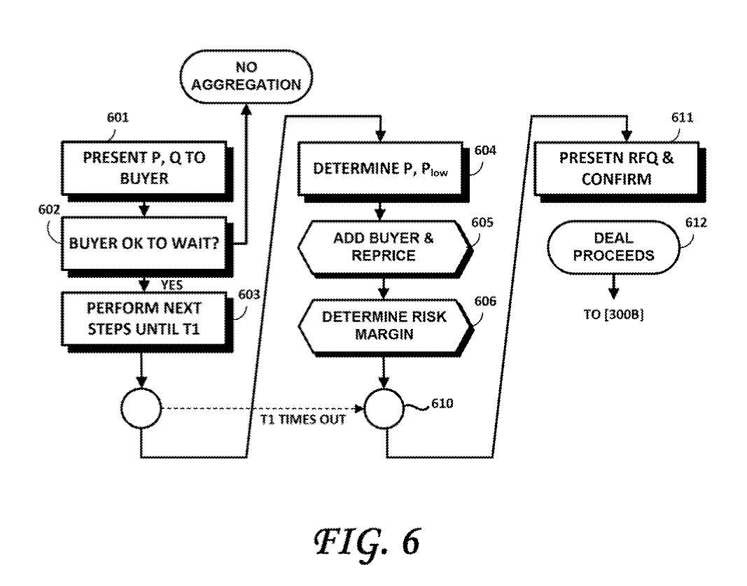

At a step 304, the matching server 140 may determine the RFQ's type. If the RFQ is for a project for which bidding is with respect to time and materials, the method 300 performs the process described with respect to the FIG. 4, if the RFQ is for a commodity without tiered pricing, the method 300 performs the process described with respect to the FIG. 5. If the RFQ is for a commodity with tiered pricing, the method 300 performs the process described with respect to the FIG. 6.

A flow point 300B indicates an end of the method 300.

In one embodiment, the matching server 140 collects feedback regarding completion of the project, or delivery of the product, and updates its database regarding (1) reliability of customers 126 in participating in aggregated RFQ's, (2) reliability of vendors 136 in performing on RFQ's, and otherwise.

In one embodiment, the method 300 returns to the flow point 300A to repeat itself with another RFQ. The method 300 may proceed concurrently with any or all of these flow points and steps with distinct RFQ's, or even with the same RFQ so long as data consistency is maintained.

### Time and Materials

FIG. 4 is a diagram of a method according to one embodiment.

A method 400 may comprise steps as shown in the figure, including at least steps as described below.

At a step 401, the matching server 140 may determine if any customers 126 joined the RFQ for aggregation within the T1 deadline. If not, there is no aggregation, and the matching server 140 may proceed with a non-aggregated RFQ. If so, the matching server 140 may proceed with the next step.

At a step 402, the method 400 may present aggregated parameters to vendors 136.

At a step 403, the matching server 140 may determine if any vendors 136 have made offers within the T2 deadline. If not, there is no aggregation, and the matching server 140 may proceed with one or more non-aggregated RFQ's. If so, the matching server 140 may proceed with the next step.

At a step 404, the matching server 140 reviews responses to the RFQ (sometimes referred to herein as “quotes”) from vendors 136, may determine which quotes are best, and if so, whether any quotes have an associated T3 deadline (response to group offer). In one embodiment, the lowest price quote may be considered the best quote. In one embodiment, the best quote may be presented to buyers, but if any best quote times out or is withdrawn for any reason, the next-best quote will be presented to buyers.

At a step 405, the method 400 may apply the aggregation repricing technique. In general, each aggregated RFQ involves an amount of savings to the aggregated customers 126 in response to the vendor 136 granting a discount for the aggregation. In one embodiment, the method 300 distributes the savings to the aggregated customers 126 in response to the quantity they contribute to the aggregated RFQ. This may have the effect that those customers 126 who contribute the most volume get their pro rata share of the savings.

In one embodiment, the method 300 also distributes an additional savings bonus, such as a 5% (for example) preference, to the customer 126 who initiated the RFQ, sometimes called the ‘Initiator’ herein. This may have the effect that the customer 126 to initiate the RFQ, which becomes an aggregated RFQ, may be rewarded for creating the opportunity, and may have the effect of encouraging customers 126 to create RFQ's. In one embodiment, the matching server 140 calculates pricing for each customer 126, may apply an extra 5% (for example) discount for the initiator, and redistributes that 5% (for example) discount among the other customers 126. This may have the effect that the initiator gets a somewhat larger share of the savings, and that the other customers 126 get a somewhat smaller share of the savings.

Optionally, the method 300 could reward some set of early customers 126, such as for example, those first customers who join before the matching server 140 may determine that aggregation is likely to draw an aggregated vendor offer. The matching server 140 could make this determination in response to a statistical history of number of early customers 126 who have been needed in the past to draw an aggregated vendor offer, or in response to the presence of an actual vendor policy or an actual aggregated vendor offer, or in response (in the case of tiered pricing, as described below) to a size of those early RFQ's in comparison to the tiered pricing quantities.

In one embodiment, the matching server 140 may determine the savings due to the aggregated RFQ, as shown in equation (421):

S=PQ−SUMᵢ(PᵢQᵢ) (421)
were S is the amount saved,
where P Q represents the price and quantity for the aggregated RFQ, and
where SUMᵢ (PᵢQᵢ) represents the total individual pricing for customers 126 i=1 to N, if the RFQ had remained un-aggregated

In one embodiment, each customer 126 may be allocated its proportion of the amount saved, as shown in equation (422):

Sᵢ=S(Qᵢ/Q) (422)
where Si is the amount saved for customer 126i, and
where Qi/Q represents the fraction of total quantity for customer 126 i

After the extra 5% (for example) discount for the initiator (P′1=95% P1) and (S′=S−5% P1 Q1), the redistributed prices are shown in equation (423):

P′ᵢ=Pᵢ((S′−S)/s) (423)
where P′ᵢ is the adjusted price for customer 126 i

At a step 406, the matching server 140 may present re-priced pricing to buyers.

At a step 407, the matching server 140 may determine a risk margin value for each buyer associated with the aggregated RFQ, and collects that risk margin from each buyer. As noted above, payment of the risk margin is optional with the buyer, but may contribute to whether the vendor decides to proceed with the aggregated RFQ, and if not paid, subjects the buyer to being removed from the aggregated RFQ.

In one embodiment, the matching server 140 may determine a risk margin as described below. this application primarily describes to system in which the matching server 140 may determine the risk margin, in the present context, there is no particular requirement for any such limitation. For example, the risk margin could be set by the vendor 136, either in response to a desired profit margin, or in response to statistical experience with the matching server 140, or otherwise.

In one embodiment, the matching server 140 may determine a measure of risk associated with aggregated RFQ. More specifically, the matching seer 140 calculates a risk, margin associated with the aggregated RFQ, in response to a measure of “trustworthiness” of the buyers.

When the matching server 140 selects an aggregated RFQ for presentation to a particular vendor 136, the matching server 140 informs the vendor 136 of the risk margin it calculated. This may have the effect that when the vendor 136 attempts to account fin the risk associated with only partial acceptance of the vendor's group offer, the vendor 136 may have a numerical amount of possible profit considered to be at risk. When the aggregated RFQ is presented to the vendor 136, the vendor 136 may use that risk margin to determine its desired profit margin, or to determine pricing it is willing to make part of its group offer. The vender 136 may instead use its own determination of possible risk, either in its own calculation of a desired profit margin, or to determine pricing, or both, or otherwise,

In one embodiment, the matching server 140 calculated a trustworthiness value for each customer 126 involved in. the aggregated RFQ. In one embodiment, the trustworthiness value may be responsive to the credit score for the customer 126. However, the trustworthiness value may also be responsive to a record of whether the customer 126 may have participated in past aggregated RFQ's. In one embodiment, the trustworthiness value for a customer 126 may be calculated as shown in equation (431):

RCₓ=(maximum credit score customer credit score)/(maximum credit score) (431)
where the result RCx is a value within the range [0,1].

In one embodiment, the risk margin RC for the aggregated RFQ may be calculated as shown in equation (432)

RC=(industry standard profit margin)*F(N)*SUMᵢ(Qᵢ/Q)RCᵢ (432)
where F(N) is a function of N, the total number of customers 126 involved in the aggregated RFQ, that decreases with N, to reflect increased risk when there are more customers 126 that may drop out;
and where the SUMᵢ represents that the value (Qᵢ/Q) RCᵢ is summed for all customers 126 involved in the aggregated RFQ.

At a step 408, the matching server 140 may determine if the risk margin was timely paid by the T3 deadline (for accepting vendor offers) set by the vendor 136. If so, the method 400 may proceed with the next step. If not, the matching server 140 removes those buyers who did not pay the risk margin from the aggregated RFQ, and returns to the step 402, where it may present the revised aggregated RFQ to vendors 136 for offers.

At a step 409, the matching server 140 may determine if the T4 deadline (for ratifying vendor offers) was timely met by the vendor 136. If so, the deal may proceed as in the aggregated RFQ, if not, the aggregated RFQ fails to proceed, and the matching server 140 returns to the step 403, where it may determine if there are any vendor offers within the T2 deadline, with which it is still possible to proceed.

At a step 410. the deal may proceed as in the aggregated RFQ. After the deal proceeds as in the aggregated RFQ, the method 400 returns to the flow point 300B in the method 300.

Commodity without tiered pricing

FIG. 5 is a diagram of a method according to one embodiment.

A method 500 may comprise steps as shown in the figure, including at least steps as described below,

At a step 501, the matching server 140 may determine if any customers 126 joined the RFQ for aggregation within the T1 deadline. If not, there is no aggregation, and the matching server 140 may proceed with a non-aggregated RFQ. If so, the matching server 140 may proceed with the next step.

In general, in a “without tiered pricing” project, the vendor 136 may determine a discount price that it will honor if the amount of product ordered exceeds a minimum quantity (Qₘᵢₙ), in many cases, the vendor 136 does not present tiered pricing and is usually the only one providing this particular product or commodity. For example, to touchpad manufacturer with a product normally selling for $500 each may offer that product at $400 each, but only if buyers commit to collectively purchase at least 1,000 units.

At a step 502, the matching server may determine if it has received a vendor offer with a price (P_{aggregated}), less than retail price (Pᵣₑₜₐᵢₗ) and commitment quantity (Qₘᵢₙ), within the T2 deadline. If not, there is no aggregation, and the matching server 140 may proceed with one or more non-aggregated RFQ's. If so, the matching server 140 may proceed with the next step.

At a step 503, the matching server 140 may apply the aggregation repricing technique as described herein with respect to the step 405.

At a step 504, the matching server 140 may present re-priced pricing to buyers.

At a step 505, the matching server 140 may determine a risk margin value for each buyer associated with the aggregated RFQ, as described herein with respect to the step 407, and collects that risk margin from each buyer. As noted above, payment of the risk margin may be optional with the buyer, but may contribute to whether the vendor decides to proceed with the aggregated RFQ, and if not paid, subjects the buyer to being removed from the aggregated RFQ.

At a step 506, the matching server 140 may determine if the risk margin was timely paid by the T3 deadline (for accepting vendor offers) set by the vendor 136. If so, the method 400 may proceed with the next step. if not, the matching server 140 removes those buyers who did not pay the risk margin from the aggregated RFQ, and may proceed with the flow point 510, where the “hot RFQ” technique may be performed.

At a step 507, the matching server 140 ma determine if the T4 deadline (for ratifying vendor offers) was timely met by the vendor 136. If so, the deal may proceed as in the aggregated RFQ. If not, the aggregated RFQ fails to proceed, and the matching server 140 returns to the step 502, where it may determine if there are any vendor offers within the T2 deadline, with which it is still possible to proceed.

At a step 508, the deal may proceed as in the aggregated RFQ. After the deal proceeds as in the aggregated RFQ, the method 400 returns to the flow point 300B in the method 300.

At the flow point 510, the method 500 is ready to perform the “hot RFQ” technique.

At a step 511, the matching server 140 may determine if its own operators may be willing to pay the risk margin in lieu of buyers. If not, the aggregated. RFQ fails to proceed, and the matching server 140 returns to the step 502, where it may determine if there are any vendor offers within the T2 deadline, with which it is still possible to proceed, if so, the method 500 may proceed with the next step.

At a step 512, the matching server 140 commits to purchase the uncommitted units of the product, taking delivery if necessary. The matching server 140 declares that the deal will proceed as in the aggregated RFQ. The method 500 may proceed in parallel with the step 508 and the step 513. This may have the effect that the deal may proceed in parallel with the “hot RFQ” technique.

At a step 513, the matching server 140 offers the uncommitted units of the product at a price (P_{hotRFQ}) which is less than retail price (Pᵣₑₜₐᵢₗ), but no less than the aggregated RFQ price (P_{aggregated}). This may have the effect that the matching server 140 itself may profit from the uncommitted units.

After the “hot RFQ” technique is finished, the method 500 may proceed with the flow point 300B, where the method 300 is finished.

Commodity with tiered pricing

FIG. 6 is a diagram of a method according to one embodiment.

A method 600 may comprise steps as shown in the figure, including at least steps as described below.

In general, in a “tiered pricing” project, the vendor 136 may have determined a set of prices (usually involving price discounts) that it has set if the amount of product ordered exceeds selected levels. For example, a vendor 136, such as a laptop reseller, with a product normally selling for $1,000 each, may offer that product at $900 each if buyers commit to collectively purchasing at least 500 units, $800 each if buyers commit to collectively purchasing at least 1,000 units, and $750 each if buyers commit to collectively purchasing at least 1,500 units. The vendor 136 may have a COGS (cost of goods sold) which allows it to price better when there is a larger order, as its total profit from the deal is sufficient. The tiered prices and quantities are referred to in this section as Pᵢ and Qᵢ respectively.

At a step 601, the matching server 140 may present a set of tiered pricing Pᵢ and Qᵢ to the buyer.

At a step 602, the matching server 140 may determine, for each buyer, if the buyer is willing to wait for an aggregated RFQ to be constructed for the tiered pricing. If those buyers are not willing to wait for aggregation, they each proceed, with a non-aggregated RFQ. If so, the matching server 140 may proceed with the next step.

At a step 603, the matching server 140 may determine, for each buyer, its T1 deadline (time for aggregation). The matching server 140 performs aggregation, as described below until the flow point 610, until the earliest T1 deadline, after which the aggregated RFQ is constructed and that deal may proceed as in the aggregated RFQ.

At a step 604, the matching server 140 may present the current retail price Pᵣₑₜₐᵢₗ and the lowest possible tiered price Plow to buyers.

At a step 605, as each buyer selects a new quantity Qᵢ to purchase, the matching server 140 may apply a repricing technique for tiered pricing and may present a revised. price P_{new} to buyers. If those new buyers do not enter the aggregated RFQ, the matching server 140 may proceed with the buyer's quantity, selects an associated Pᵢ and Qᵢ, and may proceed with the deal at the flow point 370. If so, the matching server 140 may proceed with the next step.

In one embodiment, the repricing technique for tiered pricing provides the following features:

Each time a new buyer is added to the aggregated RFQ, the repricing technique for tiered pricing may be applied.

The revised price P_{new} presented to each buyer may be always equal to or better than the retail price Pᵣₑₜₐᵢₗ available if that buyer were the only one involved in making the tiered pricing, purchase from the vendor 136.

The revised price P_{new} presented to each buyer may be responsive to the total quantity Qₜₒₜₐₗ presented to the vendor due to the aggregation of buyers.

The revised price P_{new} presented to each buyer may be responsive to the quantity Q_{new} added by the new buyer, according to equation (621):

P_{new}=(Pᵣₑₜₐᵢₗ−P_{aggregated})*(1−exp(k*(Pᵣₑₜₐᵢₗ−P_{aggregated}) (621)
where P_{new} is the revised price, Pᵣₑₜₐᵢₗ is the retail price, and P_{aggregated} is the price due to aggregation.
where exp is the exponential function e^{X},
where k is a constant coefficient, selected by the matching server 140, with the effect of apportioning the amount of savings among buyers, and between buyers and the matching server 140 itself
This may have the effect that the savings afforded to each new buyer (when that buyer pays the risk margin) ma be larger when the new buyer provides more savings to other buyers due to aggregation.
The revised price P_{new} may be further adjusted by allocating 5% (for example) of the savings Pᵣₑₜₐᵢₗ−P_{aggregated} to the initiating buyer, that is, the. first buyer to request the product. The matching server 140 may allocate 5% (for example) of the, savings Pᵣₑₜₐᵢₗ−P_{aggregated} to the initiating buyer to encourage buyers to create new RFQ's which may become aggregated RFQ's.

In one embodiment, if the new buyer has a desired quantity (Q_{new}) which may be so large that other buyers are not needed for the aggregated RFQ, the new buyer may be reallocated to a separate and new aggregated RFQ, because all the savings for the old aggregated RFQ may otherwise. be substantially entirely allocated to the new buyer, the other buyers may not save anything, and there may be nearly no opportunity for the matching server 140 to collect any of the. difference. The matching server 140 could determine statistically whether a new buyer's requested quantity (Q_{new}) is too large, even if that new quantity (Q) is not actually enough to overflow the tiered pricing presented by the vendor.

At a step 606, the matching server 140 may determine the risk margin for the new buyer, as described with respect to the step 407. If the new buyer declines to pay the risk, margin, the new buyer ma be added to a set of possible participants in the aggregated RFQ, but tiered pricing Pᵢ and Qᵢ are not updated. If the new buyer does pay the risk margin, tiered prices and quantities Pᵢ and Qᵢ are updated, including updating tiered pricing for all buyers already part of the aggregated RFQ.

At a flow point 610, the aggregation time T1 has passed, or all buyers declare they are no longer willing to wait for further aggregation.

At a step 611, the matching server 140 may present the aggregated RFQ (or a single RFQ if there is only one buyer) to all buyers, including prices and quantities Pᵢ and and orders by buyers are confirmed.

At a step 612, the deal may proceed as an the aggregated RFQ, After the deal may proceed as in the aggregated RFQ, the method 400 returns to the flow point 300B in the method 300.

Returning now to FIG. 1, in one embodiment, the matching server 140 may be configured to access one or more external databases 190. Such database(s) 190 may be accessible to the matching server 140 with or without authentication credentials and may or may not require permission to access the information stored therein. According to one embodiment, the matching server 140 may be configured to access and crawl the external database 190, to collect some or all of the information stored therein and to store at least some of the information collected in one or more of, for example, the customer database 150, the vendor database 160 and the RFQ database 170. The external database or databases 190 may be configured to store construction-related information. According to one embodiment, the external database(s) 190 may also be accessible by customers 126 via links displayed in the customer portal 120 and/or may also be accessible by vendors 136 via links thereto displayed in the vendor portal 130.

According to one embodiment, access to and collection of information from one or more external databases 190, together with the functionality described and shown herein, may provide homeowners, business owners, project managers, architects, auditors, designers, engineers, and contractors with the ability (embodied in, for example, an application on a desktop computing device or laptop or app on a mobile device) to manage their remodeling, energy retrofit and new construction projects, to identify but a few possibilities. That is, the portals 120, 130 shown in FIG. 1 may be configured for desktop computing devices as well as for mobile or tablet computing platforms. Similarly, admin access to and configuration of the matching sever 140 may be carried out via a desktop application and/or a mobile application. According to one embodiment, the external database 190 may comprise permitting and/or licensing information that may be collected to populate records within the customer, vendor. RFQ and/or green factor databases 150-180 to enable and facilitate data-driven competitive bidding, aggregation, the finding of relevant green or sustainability products and/or the scheduling service providers, to identify but a few exemplary possibilities.

According, to one embodiment, by populating one or more of the databases 150, 160, 170 and 180 with data collected from the external database(s) 190, including permitting information but could also include mandates, audit, and Building Information Model (BIM) information, customers may effectively manage both their pre-permitted and permitted projects and vendors may bid on such projects through the vendor portal 130.

### Use Case: Owner

By enabling the customer database 150 to be populated with permitting, licensing, BIM, mandate and/or rebate information from one or more external databases 190, for example, an owner may, through the customer portal 120, for example, readily ascertain the permitting status of a particular (construction, remodel, addition, etc.) project. According to one embodiment, the customer portal may be configured to organize and make accessible all the relevant information (contractor contacts, building materials distributors) for a particular project or permit. For example, the customer portal 120 may be configured to provide the customer 126 with timing reminders, calendared events and important dates relevant to his or her project and may be configured to enable connectivity directly to the municipality and his contract/designers/team. Advantageously, the owner may be provided with the ability to enable competitive bidding, group buying, deals, rebates, and the like. The customer database 150, according to one embodiment, may be further populated with sources of relevant green products (e.g., EnergyStar appliances, tit rated products) and may support targeted advertising for, e. g., sustainability products.

### Use Case: General Contractor

Similarly, by enabling the vendor database 160 to be populated with permitting, licensing, mandate and/or rebate information, for example, a general contractor may, through the vendor portal 130, for example, schedule subcontractors and inspections. The general contractor may maintain a list of “preferred” reliable vendors and/or other information he or she may want to manage, which list may be maintained and/or readily accessed through the vendor portal 130. The vendor portal 130 may also be configured, according to one embodiment, with connectivity with the project owner, the municipality and/or other team members, for example. One or more databases accessible to the vendor portal 130 may be further populated with alternative vendors, rebates, and specials, selected according to the projects the contractor may be actively managing or on which the contractor may be bidding. The vendor database 160 may, according to one embodiment, be further populated with sources of relevant green building materials and products and may also support targeted advertising for, e.g., sustainability products.

As the customer database 160 may thus be populated with data related to both permitted and as-of-yet unpermitted projects, similar projects may be aggregated to achieve further economies of scale for both customers and vendors. Projects may be aggregated not only based upon building, materials and skill-set similarities, but may also be aggregated based upon geographical proximity, whether such proximity is determined by zip code and/or Global Positioning Satellite (GPS) data, for example. Vendors (such as general contractors, for example) may have the opportunity to bid on entire individual projects, or on parts of several projects that share one or more common attributes such as labor, materials, kilowatt requirements, skill-sets, geographical proximity and the like. As shown in FIG. 7 and according to one embodiment, due to the aggregation of projects or portions thereof, vendors may have the opportunity to bid on aggregated portions 708, 710, 712 and 714 of a plurality of individual projects 702, 704 and 706. For example, paving contractors may bid on an aggregation of paving projects 712 across individual construction projects 702, 704, 706, thereby enabling the paving contractor to offer materials and labor rates that may be substantially below the corresponding material and labor rates that could be offered to homeowners in individual projects 702, 704, 706. In this manner, vendors can more effectively market to customers 126 based on individual projects, aggregated projects or portions thereof. According to one embodiment, the current status of any project may also be ascertained from permitting information collected from the external database(s) 190, to enable vendors and advertisers to market to relevant decision makers and relevant projects at the optimal time.

According, to one embodiment, the matching server 140 may be configured to aggregate the collected information (including the information collected from the permitting and licensing database(s) 190) into one or more RFQs that may be stored in the RFQ database 170. Vendors such as architects, designers, contractors and the like may then access the RFQ database 170 and bid on one or more the RFQs therein.

According, to one embodiment, the matching server 140 may be aware of the status of an pending permit and may be configured to recommend vendors, and/or materials that meet or exceed predetermined (e.g., sustainability certifications, GreenStar ratings, LEED scoring) criteria to architects or designers. In this case, the matching server 140 may be configured to recommend products to designers, architects and other decision-makers even before a permit is submitted or at the ideas stage of the design.

According to one embodiment, information regarding a pending permit application may be organized and presented through, for example, one or more websites integrated within and/or accessible from, for example, the customer portal 120 and/or the vendor portal 130. Such an integrated website may be updated contemporaneously as the project progresses through the permitting process and through the planning, execution and completion processes. The information tracked ma comprise, for example, drawings, approvals, receipts, work performed, among others.

For example, the information pulled from the external database(s) 190 and managed by the matching server 140 may comprise permit approval process and status information including one or more of the following (Note: Reviews may contain mandates and or government recommendations):
Application Submittal
Planning Preliminary Review
Real Estate Preliminary Review
Maritime Preliminary Review
Permit Desk
Electrical Review
Maritime Review
Mayor's Office on Disability
Structural Review
Engineering Review
Architectural Review
Real Estate Review
Fire Marshal Review
Environmental Review
Planning Review
Health Safety Review
Mechanical Plumbing Review
Application Status
Transportation Review
Public Utilities Review
Inspections

Exemplary building permit information stored in the external database(s) 190 that may be collected and stored in the databases 150-180 and managed by the matching server 140 may include one or more of:
Scope of work
Permit Number
Permit Type
Business Permit
Permit Valid duration (Start Date & End Date)
Owner Name and Information
Licensed Professional or Contractor Information (authorized by owner, type of contractor optional)
Includes plans? Y/N
Government or public funding? Y/N

For existing and proposed use and construction, the external database 190(s) may comprise, for example, one or more of the following:
Type of construction
Number of stories
Present Use and
Occupancy Class

For facilities, the external database(s) 190 may comprise, for example, one or more of the following:
Facility identification Number;
Site Address
Lot Identification,
Legal Description; and
Facility Type.

In addition, the matching server 140 may be configured to extract local, state and federal incentives, such as local green programs and rebates, such as Energy Star rebates from the external database(s) 190. According to one embodiment, the generated RFQs may take such incentives, programs and rebates into account when setting pricing levels for the goods and/or services specified in the RFQs. Similarly, the matching server 140 may also be configured to extract local, state and federal mandates for various aspects of construction, emissions and energy use, to name but a few of the possibilities.

According to one embodiment, the matching server 140 may be configured to monitor the status of such permits, licenses, mandates, rebates and incentives (collectively hereinafter, “permits” or “permitting information”) and to update the databases 150, 160, 170 and 180 accordingly. In one embodiment, the matching server 140 may obtain and monitor the status of such permits via a suitable Application Program Interface (API). A suitable API may be obtained, for example, from government software providers (e.g., www.accela.com and www.energov.com), which provides software to governments to manage their permitting process. Through the API, the matching server 140 may request specific information from such external databases 190 and may update its own databases accordingly. Users, such as customers 126 or vendors 136, may request this collected information through their respective portals 120, 130. Targeted search criteria may be carried out to group the permits (sonic may have been abandoned) or selected portions of the collected permits for aggregation purposes (either on behalf of customers 126 or vendors 136). Based on the information collected from the permitting agencies, one embodiment may match permits with contractors who have successfully executed on mandates or installations and present such contractors to the permit applicants or to the aggregated permit applicants. One embodiment may present or otherwise make available aggregated permits or aggregated portions of pending permits to contractors or other vendors to enable them to bid. The collected information may also be parsed and analyzed by e.g., the matching server 140 to identify buildings or owners in areas that are more likely to buy certain items. For example, building owners in certain areas in which solar power incentives or funding sources are in place may be more likely to purchase solar power installations and services. Similarly, mandates of energy or water efficient solutions may be require by certain municipalities, thus providing opportunity for aggregation.

In some States (e.g., Florida), all permit information (like building information) is public and third-parties do not require permission from the municipality to access the information. In cases in which die permitting information is not publicly available, permission will be obtained from the owner or owner's agent (e. g., contractor or project manager) to gain access to their permit, BIM, engineering plans, and the like.

Advantageously, one embodiment may enable the matching server 140 to gain access to relevant external databases 190 and populate the databases 150, 160, 170 and 180 with relevant information collected therefrom, both before the permits are approved and after the approval thereof.

According to one embodiment, the matching server 140 may be configured to monitor governmental incentives and mandates and to selectively incorporate information therefrom into the databases 150, 160, 170 and 180. Indeed, according to one embodiment, the matching server 140 may obtain mandate and incentive information from online sources such as, for example, the Database of State incentives for Renewables and Efficiency (DSIRE)™, at dsireusa.org. According to one embodiment, the matching server 140 may be configured to link selected products, services, projects, pending and issued permits, vendors and contractors with relevant federal, state and local incentives, mandates and rebates at the city, local, state and federal level. Other online resources that may be monitored and mined by the matching server 140 may comprise, for example, the California Building industry Association (www.cbia.org) and corresponding sites managed by other states, Energy Star (www.energystar.gov) and others. Advantageously, the matching server 140 may be configured to monitor public sources of mandates and incentives and to leverage that information to recommend and market products and service providers to permit applicants, building owners, individuals and vendors and contractors.

According to one embodiment, the matching server 140 may be configured for tight integration with BIMs. A BIM may be defined as a computer-based building design and documentation methodology for the creation of building-related information for design, construction and facilities management purposes. BIMs create a single coordinated and internally consistent database for a building or structure. BIM software may be obtained, for example, from Autodesk and other software providers such as the aforementioned Accela. For example. Autodesk's Seek Platform provides a product BIM library and supports a variety of file types such as .RFA (Autodesk Revit BIM format), .DWG (CAD format), .PDF and .DOC for example. Another example of a third party provider of BIM-related data is Autoquotes (www.agnet.com), which provides an electronic catalog and quotation system for the food service equipment supply industry. Other similar software companies may exist in the, for example, solar and geothermal spaces that generated specifications and exportable data including, for example, (permits, mandates, specs, BIM, environmental models) that the matching server 140 may utilize to its advantage to create RFQs for bidding.

According to one embodiment, the matcher server 140 may be configured to access repositories of such BIMs and import the information stored therein for procurement purposes throughout the lifetime of a building, from pre-permitting, through the permitting process and from construction to demolition.

For example, the present matching server 140 may be configured to create one or more RFQs that comprises imported BIM data. Indeed, data imported from a repository of RIM information to the matching server 140 may comprise a list of materials, energy model or specifications may enable the creation of one or more RFQs for a planned grouped or aggregated buy for optimal savings. Since BIM data may contain lifecycle, model, quantify of products in the building, the matching server 140 may be further configured to exchange bilateral information with the BIM software. For example, the matching server 140 may be configured to generate a “hot RFQ” or group buy deals pertaining to the RIM information received. Advantageously, the matching server 140 may be configured to leverage BIM-exported data to source products and services from project conception through eventual demolition of the building or structure. Conversely, the matching server 140 may be configured to provide information that is not in the RIM model such as, for example, fresh incentives, mandates, prices, deals (OEM or “hot RFQ”), and relevant ongoing buyers groups.

According to one embodiment, the matching server 140 may be configured to auto-generate RFQs from permitting data collected from external permitting agencies and databases. Permitting and pre-permit data may comprise information relative to the owner, building information, location, project scope, specifications, requirements, timing, and other information that, alone or in combination, may be configured into an owner-approved RFQ or inquiry on the owners' behalf. In addition to permitting information collected from one or more external databases 190, the matching server 140 may be further configured to request the approval of the owner of the building or project before making an auto-generated RFQ available, Additionally, the matching ser vet 140 may be further configured to request and obtain additional information from the project or building owner such as, for example, goals, desired LEEDS certification, GS Rating, timing, brand preference, utilities data and the like to generate a more focused RFQ. One embodiment may be configured to suggest competitive bidding information from the collected permit information. For example, a contractor may want to aggregate material purchases with other contractors doing similar projects to save on material costs.

Examples of permitting information that may be collected from external permitting databases 190 may include, for example (e.g., key wards or project categories can be used to identify relevant projects):
“Install Rooftop Solar PV System”
“New construction of gold LEED building”, 5 leaf building materials;
“Lighting retrofit”, coupled with a lighting incentive program; and
“Restaurant remodel”, coupled with energy saving mandates, Energy Star compliance, and WaterSense products.

According to one embodiment, the matching server 140 may be configured to source various products and/or services from the permitting and licensing data collected from the database 190 and/or from auto-generated RFQs. Accordingly, a mapping table may be established between the permitting and/or licensing data collected from the external database 190 and the products and/or services that are likely to fulfill the stated requirements and/or be of interest to the property owner. For example, if the permitting data collected from the external database 190 calls for the installation of a 5-ton HVAC rooftop unit, the matching server 140 may be configured to index into the mapping table and suggest great deals on Energy Star 5-ton HVACunits of various equivalent brands. Load requirements for the HVAC unit can be obtained from BIM and models HVAC units compatible to this load requirement Can also he obtain with a BIM model of the HVAC unit via external 190 database (e.g., Autodesk Seek is a library of product BIMs). The external database 190 containing the permitting or licensing information may not contain all of the required information to create a RFQ or a suitable aggregation for a group buy opportunity. In that case, the required information may be gathered through additional contacts with the property owner or building manager, onsite visits and/or any other way of acquiring the necessary information to enable the generation of RFQs and/or the aggregation of projects, portions of projects in view of setting up group buy opportunities.

According to one embodiment, the vendor database 160 and/or one or more other databases coupled to the matching, server 140, may comprise records of service providers or contractors with, for example, geographical coverage and corresponding green rating. Additional verification of vendor licenses, certifications, insurance, bonds, and references may also be collected and stored in the vendor database 160. Such stored information may then be retrieved from the vendor database 160 for incorporation into one or more RFQs, such that the RFQ(s) may be configured with only approved vendors satisfying certain selectable criteria. According to one embodiment, once the owner or owners (or other identified parties associated with the respective projects of the RFQ) approves an RFQ, the matching, server 140 may select from a list of approved or preferred service providers that will be allowed to bid for the RFQ, optionally separating labor and materials for desirable transparency.

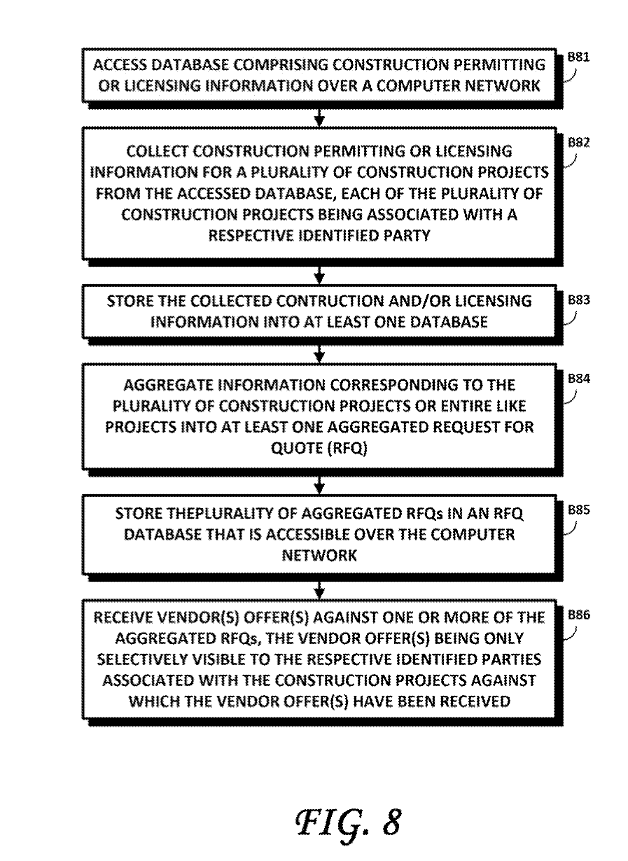

FIG. 8 is a flowchart of one embodiment. As shown at B81, a computer-implemented method may comprise accessing a database comprising construction, permitting or licensing information over a computer network. The construction, permitting or licensing information, as shown at B82, stored in the database (such as external database 190 described above) may be collected for one or a plurality of projects from the accessed database and may be stored in at least one database accessible to a matching server, as called for in B83. Each of the plurality of projects ma be associated with a respective identified party such as, for example, an owner or a developer. B84 calls for aggregating information corresponding to like respective portions of the plurality of construction projects into a plurality of aggregated requests for quotes (RFQs). Alternatively, entire like projects may be aggregated into one or more aggregated RFQ, optionally separating labor and materials. As shown at B85, the plurality of aggregated RFQs may then be stored in an RFQ database that is selectively accessible over the computer network. One or more vendors may be selected to bid on the stored RFQs and the selected vendors may be notified of the existence of the RFQs to enable them to bid thereon. Thereafter, as shown at B86, one or more vendor offers may be received against at least one of the plurality of aggregated RFQs. Advantageously, according to one embodiment, the one or more vendor offers or the savings to be derived therefrom maw only visible to the respective identified parties associated with the constructions projects against which the vendor offer(s) has/have been received.

According to one embodiment, the systems and associated computer-implemented methods described relative to FIGS. 1-8 may be further configured to offer goods and services to buyers at prices that are more competitive or that at least match the best price available online at, for example, price comparison website service such as Nextag.com.

According to one embodiment, the matching server 140 may be configured to interrogate such online aggregators for the best available prices for all or a portion of the goods, materials and services listed in the projects collected from external databases 190 or present within the RFQs presented to vendors. Such best available prices may, thereafter, form a seed price or a ceiling above which bids may not be accepted. As vendors place bids on the RFQs accessible to them, the “best available prices” are subjected to downward pressure, as vendors compete by placing increasingly lower bids in an effort to secure the contract. Moreover, the bid of the accepted offer may be kept secret or at least not actively disseminated.

According to one embodiment, as a result of the RFQs presented to selected vendors, whether for labor, products or materials, each buyer may be presented with a price that may be customized for them. That is, different buyers may be presented with different prices even for the same products, services and materials. Such differential in the prices presented to different buyers may be related to the amount purchased, or the time at which they joined the group of aggregated buyers. For example, those buyers who join the group earlier may be awarded the most competitive prices, as compared to buyers who joined the group relatively later. According to one embodiment, the prices offered to one buyer may not be revealed to the other buyers within aggregated group. According to one embodiment, since each buyer knows what he or she paid, as opposed to what prices the other buyers in the group were offered, comparative pricing schemes (like Nextag.com) may not be able to “find” the best price online, as the best prices offered to each buyer may not be known even to other buyers within the group, let alone to automated software price-gathering agents or to the Internet at large. in this manner, if the matching server 140 were to seed the bidding process with the best price available online from comparators/aggregators 192, the best and last price bid by vendors for aggregated projects or portions thereof is likely to be consistently below the lowest price for such goods or services available online. Conversely, since the vendor bids may only he available to those logged into the customer portal 120 and are opaque to those without access thereto, online aggregators and comparators 192 (FIG. 1), in the normal course of operation, will not have access to the vendor bid amounts and will, therefore, be unable to incorporate those bid amounts into their online offerings of cross-company price comparisons and offer those prices to their public. Advantageously, by leveraging aggregation of buyers, projects and/or products, and by starting the vendor bidding process at the best available online price, the matching, server 140 may consistently achieve prices for group buys that are below or at least match the lowest available price for like products or services available at any site online.

As noted above, if the risk, margin is paid for a sufficient quantity, the aggregated RFQ may proceed. If the risk margin is not paid for a sufficient quantity, the matching server 140 may determine if it may be expedient to assume some degree of risk and may undertake to pay the remaining risk margin itself. The remaining quantity of product may thereafter be resold at a price, for example, between the aggregated RFQ price and the full retail price. An RFQ in which the system has itself paid a risk margin for a predetermined quantity of units is referred to herein as a “hot RFQ”. According to one embodiment, the hot RFQ construct, particularly when combined with the opaque bidding methodology detailed herein, may be a disruptive force in the online pricing for goods and services, indeed, by forming an aggregated group buy opportunity in which the group buy organizing party (through the matching server 140, for example) assumes some of the cost of risk may result in an RFQ for a quantity of product or services that is somewhat larger than the sum of the quantities of product or services desired by the participating members of the group. In effect, when the matching server 140 undertakes to buy a certain portion of the products or services so that a threshold quantity thereof is reached, lower prices may be achieved for all participating members of the RFQ-facilitated group buy, as the RFQ(s) generated may be able to offer increased economies of scale to the bidding vendors. Offering an RFQ with a larger quantity of goods may cause vendors to further lower their prices in exchange for a larger volume, thereby further lowering prices below that which the actual participating members of the group would normally be able to command. If such a hot RFQ were to be combined with a seeding of the prices based upon the best price available online, the resultant RFQ may attract bids that are even lower than would otherwise be achievable had the matching server 140 not decided to assume a portion of the risk by paying a risk margin amount to increase the quantity of goods, materials or services to put to bid through the RFQ process. Moreover, as the vendor bids may be kept secret at least from other online aggregators and optionally from the other buyers in the group as discussed above, buyers may benefit, according to one embodiment, from non-publicly available, prices not available to non-customers 126, thereby potentially creating a private market for such goods and services that consistently outperforms the best public online comparator and price aggregator sites 192. Moreover, by collecting early stage permitting information and auto-generating RFQs for like purchases, RFQs and hot RFQs may be put out to bid, seeded with the best available online price, before others have the opportunity to do so, yielding a further competitive advantage. The system can decide to pay the risk margin itself or pass this opportunity to a third party for the “hot RFQs”.

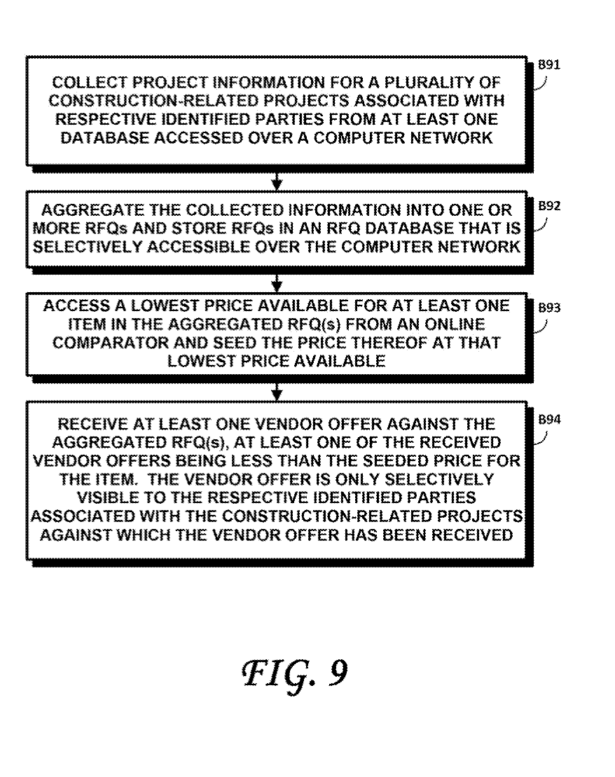

FIG. 9 is a flowchart of a computer-implemented method according to one embodiment. According to one embodiment and as shown, B91 calls for collecting project information for a plurality of construction-related projects associated with respective identified parties from at least one database accessed over a computer network. Thereafter, the collected information may be aggregated into one or more RFQs and aggregated RFQ(s) may then be stored in an RFQ database that is selectively accessible over the computer network, as shown at B92. Thereafter, as shown at B93, an online comparator/aggregator (or other online source) may be accessed to determine the lowest price available for one or more items in the aggregated RFQs. The price in the RFQs for that item or items may then be seeded with that determined lowest price available. As shown at B94, one or more vendor offers may then be received against the aggregated RFQ(s). One or more of the received vendor offers may be less than the seeded price for the lowest available price seeded item. According to one embodiment, any vendor offers received may only be selectively visible to the respective identified parties associated with the construction-related projects against which the vendor offer has been received.

According to one embodiment, the matching server 140 may undertake to purchase a predetermined amount of the item(s) in addition to an amount thereof specified in the collected information so that the at least one aggregated RFQ specifies a predetermined quantity of the item(s). This may enable the vendors to otter more advantageous bids than would otherwise be possible. As noted above, a risk margin payment may be received from at least some of the respective parties as liquidated damages against nonperformance after acceptance of a received vendor offer.

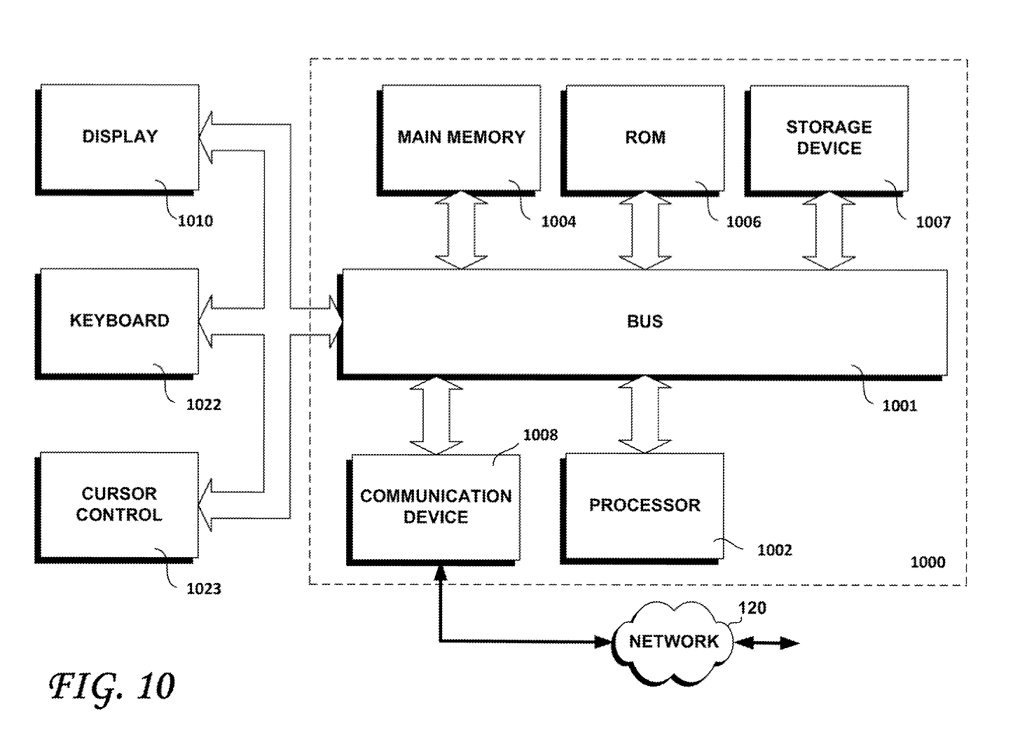

FIG. 10 illustrates a block diagram of a computer system 1000 with which embodiments may be implemented. Computer system 1000 may comprise a bus 1001 or other communication mechanism for communicating information, and one or more processors 1002 coupled with bus 1001 for processing information. Computer system 1000 may further comprises a random access memory (RAM) or other dynamic storage device 1004 (referred to as main memory), coupled to bus 1001 for storing information and instructions to be executed by processor(s) 1002. Main memory 1004 also may be used for storing temporary variables or other intermediate information during execution of instructions by processor 1002. Computer system 1000 also may comprise a read only memory (ROM) and/or other static storage device 1006 coupled to bus 1001 for storing static information and instructions for processor 1002. A data storage device 1007, such as a magnetic disk or optical disk, may be coupled to bus 1001 for storing information and instructions. The computer system 1000 may also be coupled via the bus 1001 to a display device 1010 for displaying information to a computer user. An alphanumeric input device 1022, including alphanumeric and other keys, may be coupled to bus 1001 for communicating information and command selections to processor(s) 1002. Another type of user input device is cursor control 1023, such as a mouse, a trackball, or cursor direction keys for communicating direction information and command selections to processor 1002 and for controlling, cursor movement on display 1021. The computer system 1000 may be coupled, via a communication device (e.g., WAN connectivity such as through DSL, cable modem a broadband mobile phone network, or other connections) to a network 120 and to one or more other computing devices coupled to the network 120.

Embodiments are related to the use of computer system and/or to a plurality of such computing devices for the generation of aggregated RFQs from aggregated construction-related and permitting information according to one embodiment, the computer-implemented methods and systems described herein may be provided by one or more computer systems 1000 in response to processor(s) 1002 executing sequences of instructions contained in memory 1004. Such instructions may be read into memory 1004 from another computer-readable medium, such as data storage device 1007. Execution of the sequences of instructions contained in memory 1004 causes processor(s) 1002 to spawn or carry out processes that perform the steps and have the functionality described, herein. In alternative embodiments, hard-wired circuitry may be used in place of or in combination with software instructions to implement the present invention. Thus embodiments are not limited to any specific combination of hardware circuitry and software. Indeed, it should be understood by those skilled in the art that any suitable computer system may implement the functionality described herein. The computer system may comprise one or a plurality of microprocessors working to perform the desired functions. In one embodiment, the instructions executed by the microprocessor or microprocessors are operable to cause the microprocessor(s) to perform the steps described herein. The instructions may be stored in any computer-readable medium. In one embodiment, they may be stored on a non-volatile semiconductor memory external to the microprocessor, or integrated with the microprocessor. In another embodiment, the instructions may be stored on a disk and read into a volatile semiconductor memory before execution by the microprocessor.

While certain embodiments of the disclosure have been described, these embodiments have been presented by way of example only, and are not intended to limit the scope of the disclosure. Indeed, the novel methods, devices and systems described herein may be embodied in a variety of other forms. Furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure. For example, those skilled in the art will appreciate that in various embodiments, the actual physical and logical structures may differ from those shown in the figures. Depending on the embodiment, certain steps described in the example above may be removed, others may be added. Also, the features and attributes of the specific embodiments disclosed above may be combined in different ways to form additional embodiments, all of which fall within the scope of the present disclosure. Although the present disclosure provides certain preferred embodiments and applications, other embodiments that are apparent to those of ordinary skill in the art, including embodiments Which do not provide all of the features and advantages set forth herein, are also within the scope of this disclosure, the scope of the present disclosure is intended to he defined only by reference to the appended claims.

1. A computer-implemented method, comprising:
accessing a database comprising construction permitting information over a computer network;
collecting construction permitting information for a plurality of construction projects from the accessed database and storing the collected construction permitting information into at least one database, each of the plurality of construction projects being associated with a respective identified party;
aggregating information corresponding the plurality of construction projects into a plurality of aggregated requests for quotes (RFQs);
storing the plurality of aggregated RFQs in RFQ database that is selectively accessible over the computer network; and
receiving at least one vendor offer against at least one of the plurality of aggregated RFQs;
wherein the at least one vendor offer is only selectively visible to the respective identified parties associated with the constructions projects against which the vendor offer has been received.

2. The computer-implemented method of claim 1, further comprising presenting customized prices incorporating different savings to different ones of the respective identified parties according to the received at least one vendor offer.

3. The computer-implemented method of claim 2, further comprising presenting customized prices incorporating different savings to each of the respective identified parties based upon a winning one of the received at least one vendor offer.

4. The computer-implemented method of claim 3, wherein a customized price presented to one of the respective identified parties is not visible to others of the respective identified parties.

5. The computer-implemented method of claim 3, wherein the presented customized prices are only visible to the respective identified parties.

6. The computer-implemented method of claim 1, further comprising accessing and collecting Building Information Model (BIM) information from a BIM database and wherein aggregating comprises aggregating BIM information into the plurality of aggregated RFQs.

7. The computer-implemented method of claim 1, wherein collecting is carried out with the construction permitting information comprising at least one of pre-permitted project information, permitted project information, incentive information, mandate information and rebate information.

8. The computer-implemented method of claim 1, wherein aggregating comprises aggregating information corresponding to like portions of the plurality of construction projects into the plurality of aggregated RFQs.

9. The computer-implemented method of claim 1, further comprising setting at east one seed price for each of the plurality of aggregated RFQs.

10. The computer-implemented method of claim 9, further comprising accessing at least one online price comparator to determine the at least one seed price for each of the plurality of aggregated RFQs.

11. A computer-implemented method, comprising:
collecting project information for a plurality of construction-related projects associated with respective identified parties from at least one database accessed over a computer network;
aggregating the collected information into a least one aggregated request for quote (RFQ) and storing the least one aggregated RFQ in an RFQ database that is selectively accessible over the computer network;
accessing a lowest price available for at least one item in the at least one aggregated RFQ from an online comparator and seeding the price of the at least one item at that lowest price available;
receiving at least one vendor offer against at least one of the plurality of aggregated RFQs, at least one of the received vendor offers being less than the seeded price for the at least one item, wherein the at least one vendor offer is only selectively visible to the respective identified parties associated with the construction-related projects against which the vendor offer has been received.

12. The computer-implemented method of claim 11, further comprising:
undertaking to purchase a predetermined amount of the at least one item in addition to an amount thereof specified in the collected information so that the at least one aggregated RFQ specifies a predetermined quantity of the at least one item.

13. The computer-implemented method of claim 12, further comprising, receiving a risk margin payment from at least some of the respective parties as liquidated damages against non-performance after acceptance of a received vendor offer.

14. The computer-implemented method of claim 13, further comprising paying a risk margin to reach the predetermined quantity of the at least one item in the at least one aggregated RFQ.

15. The computer-implemented method of claim 11, further comprising presenting customized prices incorporating different savings to different ones of the respective identified parties according to the received at least one vendor offer.

16. The computer-implemented method of claim 11, further comprising presenting customized prices incorporating different savings to each of the respective identified parties based upon a winning one of the received at least one vendor offer.

17. The computer-implemented method of claim 16, wherein a customized price presented to one of the respective identified parties is not visible to others of the respective identified parties.

18. The computer-implemented method of claim 11, wherein the collected information comprises building or construction permitting information.

19. The computer-implemented method of claim 11, wherein the collected. information comprises Building Information Model (BIM) information and wherein aggregating comprises aggregating BIM information into the plurality of aggregated RFQs.

20. The computer-implemented method of claim 11. wherein the collected information comprises at least one of pre-permitted project information, permitted project information, incentive information, mandate information and rebate information.

21. The computer-implemented method of claim 11, wherein aggregating comprises aggregating information corresponding to like portions of the plurality of the construction-related projects into the plurality of aggregated RFQs.

22. A computing device, comprising:
at least one processor;
at least one data storage device coupled to the at least one processor;
a plurality of processes spawned by the at least one processor, the processes including processing logic for;
accessing, a database comprising const Action permitting information over a computer network;
collecting construction permitting information for a plurality of construction projects from the accessed database and storing the collected construction permitting information into at least one database, each of the plurality of construction projects being associated with a respective identified party;
aggregating information corresponding the plurality of construction projects into a plurality of aggregated requests for quotes (RFQs);
storing the plurality of aggregated RFQs in an RFQ database that is selectively accessible over the computer network; and
receiving at least one vendor offer against at least one of the plurality of aggregated RFQs;
wherein the at least one vendor offer is only selectively visible to the respective identified parties associated with the constructions projects against which the vendor offer has been received.

23. A machine-readable medium having data stored thereon representing sequences of instructions which, when executed by a computing device, causes the computing device to:
access a database comprising construction permitting information over a computer network;
collect construction permitting information for a plurality of construction projects from the accessed database and storing the collected construction permitting information into at least one database, each of the plurality of construction projects being associated with a respective identified party;
aggregate information corresponding the plurality of construction projects into a plurality of aggregated requests for quotes (RFQs);
store the plurality of aggregated RFQs in an RFQ database that is selectively accessible over the computer network; and
receive at least one vendor oiler against at least ne of the plurality of aggregated RFQs;
wherein the at least one vendor offer is only selectively visible to the respective identified parties associated with the constructions projects against which the vendor offer has been received.
